(19) United States
(12) Patent Application Publication
(10) Pub. No.: US 2025/0391419 A1
(43) Pub. Date: Dec. 25, 2025

(54) METHOD FOR TRAINING SPEECH ENHANCEMENT NETWORK, METHOD FOR ENHANCING SPEECH, AND ELECTRONIC DEVICE

(71) Applicant: TENCENT TECHNOLOGY (SHENZHEN) COMPANY LTD, Shenzhen (CN)

(72) Inventor: Huanbin ZOU, Shenzhen (CN)

(73) Assignee: TENCENT TECHNOLOGY (SHENZHEN) COMPANY LTD, Shenzhen (CN)

(21) Appl. No.: 19/317,350

(22) Filed: Sep. 3, 2025

Related U.S. Application Data
(63) Continuation of application No. PCT/CN2024/102220, filed on Jun. 28, 2024.

(30) Foreign Application Priority Data
Aug. 17, 2023 (CN) 202311044108.6

(51) Int. Cl. G10L 21/02

(52) U.S. Cl. CPC G10L 21/02

(57) ABSTRACT

A method for training a speech enhancement network, performed by an electronic device, includes: acquiring a first clean speech sample and a noise sample, and mixing them to generate a noisy speech sample; performing noise reduction on the noisy speech sample based on the speech enhancement network to obtain an enhanced speech sample; framing the enhanced speech sample into a plurality of enhanced speech frames, classifying speech effectiveness of the enhanced speech frames, and generating a first effectiveness distribution based on classification results of the enhanced speech frames; and determining a noise reduction accuracy based on the enhanced speech sample and the first clean speech sample, determining a speech classification accuracy based on the first effectiveness distribution, determining a speech enhancement accuracy based on the noise reduction accuracy and the speech classification accuracy, and training the speech enhancement network based on the speech enhancement accuracy.

### CROSS-REFERENCE TO RELATED APPLICATIONS

This application is a continuation application of International Application No. PCT/CN2024/102220 filed on Jun. 28, 2024, which claims priority to Chinese Patent Application No. 202311044108.6 filed with the China National Intellectual Property Administration on Aug. 17, 2023, the disclosures of each being incorporated by reference herein in their entireties.

### FIELD

The disclosure relates to the technical field of artificial intelligence, and in particular, to a speech enhancement technology.

### BACKGROUND

Speech enhancement technology has been widely applied to various scenarios. With the rapid development of artificial intelligence, speech enhancement networks based on artificial intelligence are increasingly being applied to speech enhancement technologies. When processing noisy speech encompassing non-speech segments such as segments without human sound, muted segments, or noise segments, residual noises may be generated, and the quality of the speech enhancement is therefore reduced.

### SUMMARY

According to an aspect of the disclosure, a method for training a speech enhancement network, performed by an electronic device includes, acquiring a first clean speech sample and a noise sample, and mixing the first clean speech sample with the noise sample to generate a noisy speech sample; performing noise reduction on the noisy speech sample based on the speech enhancement network to obtain an enhanced speech sample; framing the enhanced speech sample into a plurality of enhanced speech frames, classifying speech effectiveness of the plurality of enhanced speech frames, and generating a first effectiveness distribution of the enhanced speech sample based on classification results of the plurality of enhanced speech frames; and determining a noise reduction accuracy of the speech enhancement network based on the enhanced speech sample and the first clean speech sample, determining a speech classification accuracy of the speech enhancement network based on the first effectiveness distribution, determining a speech enhancement accuracy of the speech enhancement network based on the noise reduction accuracy and the speech classification accuracy, and training the speech enhancement network based on the speech enhancement accuracy.

According to an aspect of the disclosure, an apparatus for training a speech enhancement network, includes at least one memory configured to store computer program code; and at least one processor configured to read the program code and operate as instructed by the program code, the program code including speech sample mixing code configured to cause at least one of the at least one processor to acquire a first clean speech sample and a noise sample, and mix the first clean speech sample with the noise sample to generate a noisy speech sample; speech sample enhancement code configured to cause at least one of the at least one processor to perform noise reduction on the noisy speech sample based on the speech enhancement network to obtain an enhanced speech sample; effectiveness classification code configured to cause at least one of the at least one processor to frame the enhanced speech sample into a plurality of enhanced speech frames, classify speech effectiveness of the plurality of enhanced speech frames, and generate a first effectiveness distribution of the enhanced speech sample based on classification results of the plurality of enhanced speech frames; and network training code configured to cause at least one of the at least one processor to determine a noise reduction accuracy of the speech enhancement network based on the enhanced speech sample and the first clean speech sample, determine a speech classification accuracy of the speech enhancement network based on the first effectiveness distribution, determine a speech enhancement accuracy of the speech enhancement network based on the noise reduction accuracy and the speech classification accuracy, and train the speech enhancement network based on the speech enhancement accuracy.

According to an aspect of the disclosure, a non-transitory computer-readable storage medium, storing computer code which, when executed by at least one processor, causes the at least one processor to at least acquire a first clean speech sample and a noise sample, and mix the first clean speech sample with the noise sample to generate a noisy speech sample; perform noise reduction on the noisy speech sample based on the speech enhancement network to obtain an enhanced speech sample; frame the enhanced speech sample into a plurality of enhanced speech frames, classify speech effectiveness of the plurality of enhanced speech frames, and generate a first effectiveness distribution of the enhanced speech sample based on classification results of the plurality of enhanced speech frames; and determine a noise reduction accuracy of the speech enhancement network based on the enhanced speech sample and the first clean speech sample, determine a speech classification accuracy of the speech enhancement network based on the first effectiveness distribution, determine a speech enhancement accuracy of the speech enhancement network based on the noise reduction accuracy and the speech classification accuracy, and train the speech enhancement network based on the speech enhancement accuracy.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. One of ordinary skill would understand that aspects of some embodiments may be combined together or implemented alone.

FIG. 1 is a schematic diagram according to some embodiments;

FIG. 2 is an exemplary schematic flowchart of a method for training a speech enhancement network according to some embodiments;

FIG. 3 is a schematic diagram of a function module of an overall system framework to which a method for training according to some embodiments is applied;

FIG. 4 is a schematic diagram of a structural design of a neural network model inference module according to some embodiments;

FIG. 5 is a structural diagram of a speech enhancement network acting based on an end-to-end model according to some embodiments;

FIG. 6 is a schematic diagram of an exemplary process for obtaining speech enhancement accuracy according to some embodiments;

FIG. 7 is a schematic diagram of another exemplary process for obtaining speech enhancement accuracy according to some embodiments;

FIG. 8 is a schematic diagram of yet another exemplary process for obtaining speech enhancement accuracy according to some embodiments;

FIG. 9 is a schematic diagram of still another exemplary process for obtaining speech enhancement accuracy according to some embodiments;

FIG. 10 is a schematic diagram of an exemplary process of obtaining a conversion loss according to some embodiments;

FIG. 11 is a schematic diagram of a perceptual evaluation of speech quality (PESQ) score result in a test process according to some embodiments;

FIG. 12 is a schematic diagram of a scale-invariant signal-to-noise ratio (SI-SNR) score result in a test process according to some embodiments;

FIG. 13 is a schematic diagram of a mean opinion score objective listening (MOS_OVL) score result in a test process according to some embodiments;

FIG. 14 is an exemplary schematic flowchart of a method for enhancing speech according to some embodiments;

FIG. 15 is an exemplary schematic structural diagram of an apparatus for training a speech enhancement network according to some embodiments;

FIG. 16 is an exemplary schematic structural diagram of an apparatus for enhancing speech according to some embodiments;

FIG. 17 is a block diagram of some structures of a terminal according to some embodiments; and

FIG. 18 is a block diagram of some structures of a server according to some embodiments.

### DESCRIPTION OF EMBODIMENTS

To make the objectives, technical solutions, and advantages clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope.

In the following descriptions, terms such as “some embodiments” describe a subset of all possible embodiments. It may be understood that “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

The terms “module [s]” or “unit [s]” may refer to hardware logic, a processor or processors executing computer software code, or a combination of both. The “modules” or “units” may also be implemented in software stored in the memory of a computer or a non-transitory computer-readable medium, where the instructions of each unit are executable by a processor to thereby cause the processor to perform the respective operations of the corresponding module or unit.

Each module or unit may exist separately or be combined into one or more units. Some modules or units may be further split into multiple smaller function subunits, thereby implementing the same operations without affecting the technical effects of the embodiments. The modules or units are divided based on logical functions. In actual applications, a function of one module or unit may be realized by multiple modules or units, or functions of multiple modules or units may be realized by one module or unit. In some embodiments, the apparatus may further include other modules or units. In actual applications, these functions may also be realized cooperatively by the other modules or units, and may be realized cooperatively by multiple modules or units.

Terms such as “first”, “second”, “third”, and “fourth” in the disclosure are used for distinguishing between similar objects, and are not necessarily used for describing the particular sequence or order. The data used in this way are exchangeable so that some operations can be performed in a sequence different from those shown or described herein, for example. The terms “comprise”, “include”, “have”, and any variants thereof are intended to cover non-exclusive inclusion. For example, a process, a method, a system, a product, or an apparatus that encompasses a series of steps or units is not necessarily limited to those steps or units expressly listed, but can include other steps or units not expressly listed or inherent to the process, the method, the product, or the apparatus.

The term “a plurality of” indicates two or more, the terms “greater than”, “less than”, “exceed”, for example, are to be interpreted as excluding the present number, and the terms “above”, “below”, “within”, for example, are to be interpreted as including the present number.

When related processing may be performed according to data related to a target object characteristic, such as attribute information or an attribute information set of a target object, permission or consent of the target object is first obtained, and collection, use, or processing, for example, of these data should comply with related laws and regulations and standards. The target object may be a user. When attribute information of the target object is to be acquired, individual permission or individual consent of the target object is obtained through a pop-up window or skipping to a confirmation page. After the individual permission or the individual consent of the target object is explicitly obtained, data related to the target object may be obtained.

In various application scenarios such as a call and a video conference, a plurality of audio processing operations may be encompassed in an audio signal processing link. After speech enhancement and noise reduction processing is performed on an audio signal, an enhanced signal may be transmitted into automatic gain control (AGC). The module may adjust the loudness magnitude of an audio stream, suppress a part having a volume that is too high, and perform volume compensation on a part having a volume that is too low. Thus, volume fluctuations may be reduced. This may lead to a problem where, after the audio stream flows through the noise reduction module, if distinct residual noises exist in a non-speech segment (the non-speech segment is a speech segment including no effective human sound, the effective human speech being an audio signal having signal strength greater than a preset strength threshold and satisfying a signal continuity requirement), the AGC probably amplifies a residual noise signal in these segments. In this way, noise energy may be increased. Due to discontinuity of the residual noises, speech fluency, as well as listening and sensing quality, may be reduced.

When the speech enhancement network performs speech enhancement processing on noisy speech that includes a non-speech segment, residual noises are often generated, thereby reducing the quality of the enhanced speech.

A method for training a speech enhancement network, a method for enhancing speech, and an electronic device are provided. When speech enhancement processing is performed on noisy speech including a non-speech segment, residual noises can be reduced, thereby improving the quality of the speech enhancement. In some embodiments, a noise reduction effect of the speech enhancement algorithm may be improved without introducing additional amounts of computation, and noise suppression in non-speech segments may be significantly improved.

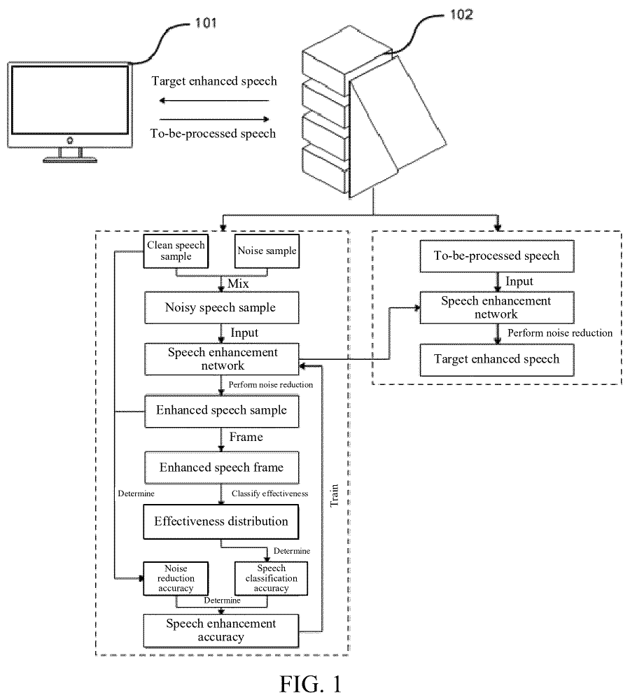

A schematic diagram, according to some embodiments, is shown in FIG. 1. Some embodiments may include a terminal 101 and a server 102. The terminal 101 may be connected to the server 102 through a communication network.

The server 102 may acquire a clean speech sample and a noise sample, and mix the clean speech sample with the noise sample to form a noisy speech sample; perform noise reduction on the noisy speech sample based on the speech enhancement network, and obtain an enhanced speech sample; frame the enhanced speech sample into a plurality of enhanced speech frames, classify speech effectiveness of each enhanced speech frame, and generate effectiveness distribution of the enhanced speech sample according to a classification result of each enhanced speech frame; and determine noise reduction accuracy of the speech enhancement network according to the enhanced speech sample and the clean speech sample, determine speech classification accuracy of the speech enhancement network according to the effectiveness distribution, determine the speech enhancement accuracy of the speech enhancement network according to the noise reduction accuracy and the speech classification accuracy, and train the speech enhancement network based on the speech enhancement accuracy. Subsequently, the terminal 101 may transmit a to-be-processed speech to the server 102. The server 102 performs noise reduction on the to-be-processed speech based on a trained speech enhancement network, and obtains the target enhanced speech. After obtaining the target enhanced speech, the server 102 may transmit the target enhanced speech to the terminal 101. The terminal 101 may further process or play the target enhanced speech.

The server 102 may be an independent physical server, or a server cluster or distributed system composed of a plurality of physical servers, or a cloud server providing basic cloud computation service such as cloud service, a cloud database, cloud computation, a cloud function, cloud storage, network service, cloud communication, middleware service, domain name service, security service, a content delivery network (CDN), big data, and an artificial intelligence platform. The server 102 may be a node server in a blockchain network.

The terminal 101 may be, but is not limited to, a smart phone, a tablet computer, a laptop computer, a desktop computer, a smart speaker, a smart watch, or an in-vehicle terminal, for example. The terminal 101 and the server 102 may be connected directly or indirectly in a wired or wireless communication mode, which is not limited.

The method for enhancing is applicable to a plurality of scenarios, such as call noise reduction, a video conference, a speech recognition front end, and a live video on demand application. In a call noise reduction scenario, noise disturbance may exist in a call, affecting call quality. Through the trained speech enhancement network, residual noise in a non-speech segment can be effectively reduced, and definition and intelligibility of the speech can be improved, thereby enhancing the call quality. In a video conference scenario, participants perform speech communication through microphones. Various noises, such as background noises and computer fan sounds, may exist in a conference environment. These noises can be effectively suppressed by applying the trained speech enhancement network, and the speech recognition accuracy, as well as the auditory experience of the participants, can be improved. In a speech recognition front-end scenario involving, for example, a mobile phone intelligent speech assistant and an in-vehicle speech assistant, noise processing on a speech front end takes an important role. With the trained speech enhancement network, the negative impact of noises on speech recognition can be reduced, and accuracy and stability of speech recognition can be improved. In a live video on demand application, audio quality is crucial to the user experience. With the trained speech enhancement network, definition and a quality of audio can be improved, and noise disturbance can be reduced, so that the user obtains a better auditory experience.

The method according to some embodiments may be applied to different scenarios, including, but not limited to, cloud technologies, artificial intelligence technologies, intelligent transportation technologies, and assisted driving technologies.

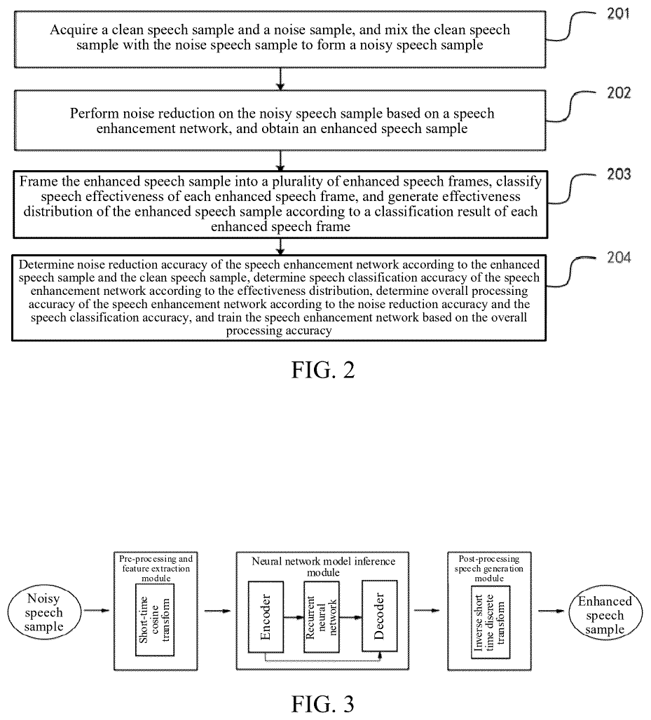

With reference to FIG. 2, an exemplary schematic flowchart of a method for training a speech enhancement network according to some embodiments is shown in FIG. 2. The method for training a speech enhancement network may be performed by an electronic device, for example, the server 102 in FIG. 1. The method for training a speech enhancement network includes, but is not limited to, the following operation 201 to operation 205.

Operation 201: Acquire a clean speech sample and a noise sample, and mix the clean speech sample with the noise sample to form a noisy speech sample.

In some embodiments, the clean speech sample indicates a clear speech signal not disturbed by noise. For example, a quality of the speech signal may be evaluated by employing a preset speech quality evaluation standard (such as an evaluation standard based on a signal-to-noise ratio (SNR) in a time domain or a frequency-domain and an evaluation standard based on linear prediction coefficients (LPCs)). A speech signal satisfying a preset clean speech condition (for example, the SNR and the LPC are within corresponding preset clean signal ranges) is taken as the clean speech sample. These speeches may be recorded or acquired from a pre-established speech database. The clean speech sample is a clean sample. To obtain a high-quality clean sample, attempt may be made to avoid background noise may be avoided. A professional microphone may be used for recording. A good sound quality and diversity of speech contents are maintained.

In some embodiments, the noise sample indicates a speech signal disturbed by different types of noises. A quality of a speech signal may be evaluated by employing a preset speech quality evaluation standard (such as an evaluation standard based on an SNR in a time domain and a frequency domain and an evaluation standard based on LPCs). A speech signal satisfying a preset noise speech condition (for example, the SNR and the LPC are within corresponding preset noise signal ranges) is taken as the noise sample. These speeches may be collected from the real world. For example, background noises in daily life are recorded through the microphone in different environments or extracted from a noise database, such as simulated noises, noises in a vehicle, and environment noises in a coffee shop. The noise speech collection may cover various environments and various types of noises, so that a trained model has a better generalization capability.

In some embodiments, the noisy speech sample is speech generated after the clean speech sample and the noise sample are obtained and mixed with each other. Some noise samples are mixed based on the clean speech sample, so that the clean speech sample is noisy. The noisy speech sample may be configured for simulating a speech in an actual scenario. In the scenarios such as a call, a video conference, a speech recognition front end, and a live video on demand application, speech acquired by a device may be noisy. The noisy speech sample formed through mixing may be configured for subsequent model training.

In some embodiments, the clean speech sample is mixed with the noise sample to form the noisy speech sample through the following several methods. For example, a clean speech sample signal and a noise sample signal may be added at a ratio. A signal-to-noise ratio is adjusted by controlling an energy ratio of the clean speech sample signal to the noise sample signal, to form a noisy speech sample. The magnitude of a clean speech sample signal and the magnitude of a noise sample signal may be separately adjusted, and then multiplied to obtain a mixed signal. A signal-to-noise ratio may be controlled by adjusting a magnitude adjustment parameter, to form a noisy speech sample. A noise sample signal may be processed through a filter, and then added with a clean speech sample signal, to form a noisy speech sample. Short-time Fourier transform may be performed on a clean speech sample signal and a noise sample signal. A transformed clean speech sample signal and a transformed noise sample signal are mixed in a frequency domain, and then undergo inverse transform to obtain a mixed signal in a time domain, to form a noisy speech sample. A deep learning model, such as a generative adversarial network (GAN), and an autoencoder, is trained to learn how to mix the clean speech sample with the noise sample, to form a noisy speech sample. A proper mixing method may be selected under different scenarios and application demand, to obtain the noisy speech sample, which is not limited in some embodiments.

Operation 202: Perform noise reduction on the noisy speech sample based on the speech enhancement network, and obtain an enhanced speech sample.

The speech enhancement network, a neural network model configured for processing the noisy speech in some embodiments, is configured for attenuating a noise signal in the noisy speech, to enhance an effective speech signal in the noisy speech. The speech enhancement network is intended to reduce disturbance of noises on the speech signal through learning, to improve definition and audibility of the speech. The speech enhancement network may be a deep learning model, such as a convolutional neural network (CNN) and a recurrent neural network (RNN). The network may be configured for performing noise reduction on the speech, and outputting an enhanced speech signal after noise reduction is performed the noisy speech input.

In some embodiments, the enhanced speech sample indicates an enhanced speech signal obtained by processing, by the speech enhancement network, the noisy speech sample. Such a process may be implemented by inputting the noisy speech sample to the speech enhancement network, and acquiring a noise reduction result output by the speech enhancement network. The noise reduction result is the above enhanced speech sample. The enhanced speech sample is to feature weak noise disturbance and high speech definition.

In some embodiments, after to undergo frequency-domain conversion, the noisy speech sample is input to the speech enhancement network for feature processing. A short-time cosine spectrum estimation of the noisy speech sample is determined based on an extracted transform mask. Finally, inverse transform is performed, to obtain the enhanced speech sample. Frequency-domain transform is performed on the noisy speech sample, and an original frequency-domain feature of the noisy speech sample is obtained; the original frequency-domain feature is mapped repeatedly based on the speech enhancement network, a mapped feature is obtained, time sequence information is extracted from the mapped feature, a time sequence feature is obtained, the mapped feature and the time sequence feature are spliced, a spliced feature is obtained, the spliced feature is mapped repeatedly, and a transform mask is obtained; the original frequency-domain feature is modulated based on the transform mask, and a target frequency-domain feature is obtained; and inverse transform of the frequency-domain transform is performed on the target frequency-domain feature, and the enhanced speech sample is obtained.

In some embodiments, before the noisy speech sample is input to the speech enhancement network, frequency-domain transform may be first performed. An objective of performing the frequency-domain transform on the noisy speech sample is to convert a speech signal in a time domain into a frequency domain representation, so that richer frequency-domain information can be obtained. Speech enhancement can be better performed, and the original frequency-domain feature of the noisy speech sample is finally obtained.

In some embodiments, a plurality of methods are available for frequency-domain transform. For example, the frequency-domain transform may be implemented through fast Fourier transform (FFT). The time-domain signal is converted into the frequency-domain signal through the fast Fourier transform, to convert the noisy speech sample signal from the time domain into the frequency domain. Energy distribution of the speech signal at different frequencies can be acquired, and more refined analysis and processing can be performed on the noisy speech sample signal. The frequency-domain feature may be extracted from the noisy speech sample through a discrete cosine transform (DCT) operation.

In some embodiments, before the frequency-domain transform is performed, the noisy speech sample signal may be re-sampled, and then undergoes the frequency-domain transform. The discrete cosine transform is described as an example herein. For re-sampling the noisy speech sample signal, audio data of all sampling rate types may be re-sampled to 48 kHz. It is ensured that audio having different sampling rates can be centrally processed and analyzed in subsequent processing, and mismatching of the sampling rates can be avoided. After the re-sampling operation is completed, time-domain framing and windowing is then performed on a long audio signal in the signal, and local processing on the signal is performed in the time domain. Through framing, an original audio signal can present temporal stability, facilitating subsequent frequency-domain analysis. The original audio signal may be segmented into a plurality of short signals having a fixed length according to a single-frame length 1024 and a frame shift 512 (overlap 512). Each signal is modulated through a Hamming window, to prevent a spectrum leakage and maintain accuracy and stability of the frequency-domain analysis. After the framing and windowing operation is ended, a discrete cosine transform operation is performed on a modulated signal, to extract a frequency-domain feature and obtain a frequency-domain representation of the noisy speech sample signal, for example, the original frequency-domain feature of the noisy speech sample. A combination of the audio signal framing and windowing operation and the cosine transform operation may be referred to as short-time discrete cosine transform (SDCT).

In some embodiments, after receiving the frequency-domain representation (for example, the original frequency-domain feature) of the noisy speech sample signal input, the speech enhancement network may perform feature processing on the original frequency-domain feature. The speech enhancement network is to perform feature processing on the original frequency-domain feature, and obtain a short-time cosine estimation of the speech signal input; and then perform the transform, and obtain an enhanced speech. In the speech enhancement network, all modules may correspondingly perform mapping, time sequence extraction, or splicing, for example. Finally, modulation and inverse transform, for example, are performed on output of the speech enhancement network, to generate the enhanced speech signal.

In some embodiments, the speech enhancement network is provided with a plurality of layers of structures. Processes such as mapping, time sequence extraction, and splicing performed by all the modules in the speech enhancement network in some embodiments are described in sequence as follows:

Mapping: The speech enhancement network is provided with a function module for mapping an input feature. The module is configured to map the original frequency-domain feature, and obtain the mapped feature. A nonlinear variation may be introduced into the module. An expression capability and a distinctiveness of the feature are enhanced, effective information is better captured from the original frequency-domain feature, and a more discriminative representation is provided. In the speech enhancement network, an encoder module is configured to map the original frequency-domain feature. The encoder module is composed of a series of EncConv2d structures with a two-dimensional convolution (Conv2d) as a kernel. A convolution kernel size of each EncConv2d layer is set to (5, 2). Herein, 5 denotes a frequency-domain field of view. When a convolution operation is performed, each convolution kernel takes into account feature information of five previous frequency-domain positions and five subsequent frequency-domain positions. 2 denotes a time-domain field of view. Each convolution kernel takes into account features of two adjacent signals. Reference is made to information of a previous frame for processing of a current frame. By introducing the time-domain field of view, a time sequence relation between signals can be better captured. Reference is made to a previous signal for analysis and processing of the feature of each signal. A convolution stride of each EncConv2d layer is set to (2, 1). This indicates that when the convolution operation is performed, a frequency-domain dimension of a feature image is halved layer by layer, and a time-domain dimension remains unchanged. Through such a setting, the dimension of the feature image and an amount of computation are reduced, and an important frequency-domain feature is retained. By halving the frequency-domain dimension layer by layer, the dimension and the amount of computation can be reduced while an input signal can be effectively represented.

Time sequence extraction: The speech enhancement network is provided with a function module for extracting time sequence information from the mapped feature, to extract a dynamic change condition of audio in a time dimension. By extracting the time sequence feature, a time-varying characteristic of an audio signal is modeled, and the time sequence relation of the audio is captured. The speech enhancement network may be provided with a recurrent neural network (RNN) or a convolutional neural network (CNN) for time sequence extraction. Recurrent neural networks (RNNs) formed by stacking gated recurrent units (GRUs) are employed in some embodiments. The RNNs are configured to extract and analyze inter-frame time sequence information of the audio signal. The RNNs receive a mapped feature output by a last EncConv2d layer, extract and analyze time sequence information, and obtain a time sequence feature.

Splicing: The speech enhancement network is provided with a function module for splicing the mapped feature and the time sequence feature. The module is configured to combine the mapped feature and the time sequence feature, to fuse information of the mapped feature and the time sequence feature. Thus, the spliced feature obtained may include information in the frequency domain and information in the time domain. The spliced feature obtained provides a richer and more comprehensive audio representation. In the speech enhancement network, a decoder module is configured to splice the mapped feature and the time sequence feature. The decoder module is composed of a series of DecTConv2d. Each DecTConv2d layer takes a transpose two-dimensional convolution (ConvTranspose2d) as a main operation, and has the same parameters as those of the EncConv2d layer in a corresponding encoder, to restore a signal dimension. After receiving the original frequency-domain feature of the short-time cosine transform representation of the noisy speech, the encoder module extracts high-dimensional features layer by layer through a series of EncConv2d layers, and transfers corresponding output in a skip connection mode, to transfer the mapped feature to the DecTConv2d layer. The RNNs receive the output feature from the last EncConv2d layer, extracts and analyzes the time sequence information, and transfers the time sequence information to a decoder as input. The decoder splices the mapped feature and the time sequence feature, and obtains the spliced feature.

Repeated mapping: In some embodiments, the spliced feature may be mapped repeatedly, and more nonlinear transform is introduced, to further extract and enhance useful information in the spliced feature and improve a representation capability and distinctiveness. The spliced feature may be mapped repeatedly through the decoder module in the speech enhancement network, and the transform mask is generated based on a spliced feature obtained after repeated mapping. The transform mask, one mask vector configured for modulating the original frequency-domain feature, may change a frequency-domain attribute of the feature by controlling the gain or phase, for example, of a spectrum. The transform mask is generated to perform directional adjustment and optimization on the original frequency-domain feature, to achieve a target enhancement effect. Thus, the decoder module receives the output from the RNNs and the encoder module, performs dimension upgrading layer by layer, and finally generates the cosine transform mask.

In some embodiments, after the transform mask is obtained, the original frequency-domain feature may be modulated based on the transform mask, and a target frequency-domain feature is obtained. The inverse transform of the frequency-domain transform is performed on the target frequency-domain feature, and the enhanced speech sample is obtained. Processes of subsequent modulation and inverse transform in some embodiments are described in sequence below.

Modulation: A function module configured to modulate the original frequency-domain feature based on the transform mask is provided in some embodiments. The module is configured to modulate the original frequency-domain feature through the transform mask generated. The magnitude or phase, for example, of the original frequency-domain feature are changed as instructed by the transform mask. A modulation operation may enhance particular frequency bands of the target signal or suppress noise frequency bands as demanded, to achieve a sample enhancement effect. After the transform mask of the speech signal is obtained, a short-time cosine spectrum of the original noisy speech, for example, the original frequency-domain feature may be modulated, and the short-time cosine spectrum estimation of the noisy speech sample is obtained as a modulated target frequency-domain feature.

Inverse transform: A function module for performing inverse transform of the frequency-domain transform on the modulated target frequency-domain feature is provided in some embodiments. The module is configured to convert the target frequency-domain feature back to the time-domain signal. The enhanced speech signal, for example, the enhanced speech sample can be obtained. Thus, the speech signal is enhanced and optimized in the frequency-domain, and the definition and robustness of the speech may be improved. After the short-time cosine spectrum of the noisy speech sample is obtained (for example, the target frequency-domain feature), the inverse short time discrete cosine transform (iSDCT) corresponding to the SDCT is performed, to obtain a time-domain estimated value of the enhanced speech signal as a final enhanced speech sample.

A process of obtaining the enhanced speech sample is described in detail below with reference to an overall system framework to which the method for enhancing speech is applied in some embodiments.

In some embodiments, with reference to FIG. 3, a schematic diagram of a function module of an overall system framework to which a method for training a speech enhancement network is applied according to some embodiments is shown. The overall system framework is provided with three modules that are an audio signal pre-processing and feature extraction module (corresponding to the above frequency-domain transform process), a neural network model inference module (corresponding to the above mapping, time sequence information extraction, splicing, and repeated mapping processes performed based on the speech enhancement network), and a post-processing speech generation module (corresponding to the above modulation and inverse transform process) respectively.

The pre-processing and feature extraction module first re-samples the noisy speech sample signal xₙ, to re-sample audio data of all sampling rate types to 48 KHz. After the re-sampling operation is completed, time-domain framing and windowing is performed on a long audio signal in the signal. An original audio signal is segmented into a plurality of short signals having a fixed length according to a single frame length 1024 and a frame shift 512 (overlap 512), and each signal is modulated through the Hamming window, to prevent spectrum leakage. After the framing and windowing operation is ended, a DCT operation is performed on a modulated signal to extract a frequency-domain feature, and an original frequency-domain feature Xₖ of the noisy speech sample signal xₙ is obtained. The combination of the audio signal framing and windowing operation and the cosine transform operation may be referred to as SDCT.

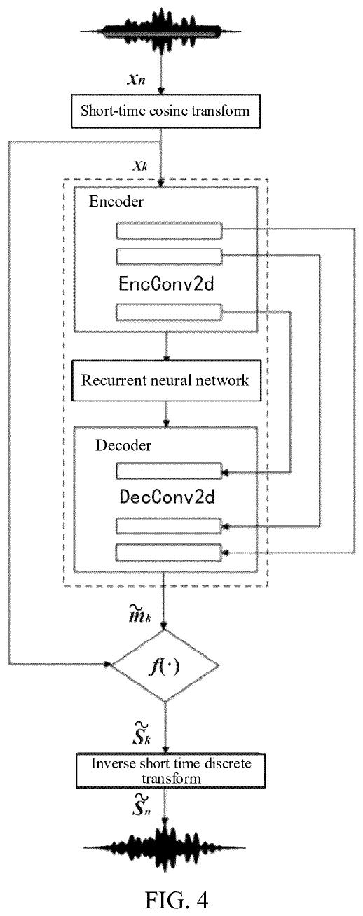

For the neural network model inference module, with reference to FIG. 4, a schematic diagram of a structural design of a neural network model inference module according to some embodiments is shown. The neural network model inference module may include an encoder, a recurrent neural network, and a decoder. The encoder is composed of an EncConv2d structure having a two-dimensional convolution (Conv2d) as a kernel. A convolution kernel size of each EncConv2d layer is (5, 2), which indicates that 5 denotes a frequency-domain field of view, and 2 denotes a time-domain field of view. Reference is made to a previous signal for analysis and processing of the feature of each signal. A convolution stride is (2,1). A number of frequency-domain features of the signal can be halved layer by layer, and a number of time-domain frames can remain unchanged, so that the dimension and the amount of computation can be reduced. The encoder is composed of DecTConv2d having a transpose two-dimensional convolution (ConvTranspose2d) as a kernel. A parameter of each DecTConv2d layer is identical to the parameter of the corresponding EncConv2d, so that the signal dimension is restored. In some embodiments, the recurrent neural networks (RNNs) formed by stacking GRUs are provided between the encoder and the decoder. The RNNs are configured to extract and analyze inter-frame time sequence information of the audio signal. A working flow of the neural network model inference module is that the encoder receives the short-time cosine transform representation, for example, the original frequency-domain feature Xₖ, of the noisy speech sample from the signal pre-processing module; extracts high-dimensional features layer by layer through the EncConv2d; and transfers corresponding output to the DecTConv2d in a skip connection mode. The RNNs receive the output feature from the last EncConv2d layer of the encoder, extract and analyze the time sequence information, and input the time sequence information to the decoder. The decoder receives the output from the RNNs and the encoder, performs dimension upgrading layer by layer, and finally obtains the cosine transform mask mk.

The post-processing speech generation module modulates the original frequency-domain feature based on the transform mask, and obtain the short-time cosine spectrum estimation of the noisy speech sample signal as a modulated target frequency-domain feature \tilde{S}ₖ. An expression of the target frequency-domain feature \tilde{S}ₖ is as follows:

$${\tilde{S}}_{k} = {X}_{k} \cdot {\tilde{m}}_{k}$$

After the target frequency-domain feature \tilde{S}ₖ is obtained, an iSDCT operation corresponding to the SDCT is finally performed on the target frequency-domain feature \tilde{S}ₖ, to obtain a time-domain estimated value of the enhanced speech signal as a final enhanced speech sample \tilde{s}ₙ.

In the above implementation, the frequency-domain transform is performed on the noisy speech sample, and the corresponding original frequency-domain feature is obtained. Thus, the noisy speech sample signal is converted from the time domain to the frequency domain, and the energy distribution of the noisy speech sample at different frequencies is obtained, which facilitates subsequent more refined analysis and processing based on the original frequency-domain feature. The original frequency-domain feature is mapped repeatedly through the speech enhancement network, and the mapped feature is obtained. Thus, the dimension and the amount of computation are reduced while the input signal is effectively represented. The time sequence information is extracted from the mapped feature, the time sequence feature is obtained, and thus the inter-frame time sequence information of the audio signal is extracted and analyzed. The mapped feature and the time sequence feature are spliced, and the spliced feature is obtained. Thus, the spliced feature obtained includes information in the frequency domain and information in the time domain, and richer and more comprehensive audio representation is provided. The spliced feature is mapped repeatedly, and the transform mask configured for performing directional adjustment and optimization on the original frequency-domain feature is obtained, to achieve the target enhancement effect. The original frequency-domain feature is modulated based on the transform mask, so that the speech signal may be improved and optimized in the frequency domain, and the target frequency-domain feature after target enhancement is obtained. Finally, the inverse transform of the frequency-domain transform is performed based on the target frequency-domain feature, and the enhanced speech sample is obtained. Through the above processing, the enhanced speech sample has the high definition and robustness.

In some embodiments, in addition to the speech enhancement network having the above framework, an end-to-end model may be taken as the speech enhancement network, to obtain the enhanced speech sample. The end-to-end model directly takes original input as input of a network, and outputs a final enhanced speech result, omitting an intermediate feature processing and operation division. The speech enhancement network acting based on the end-to-end model is described below.

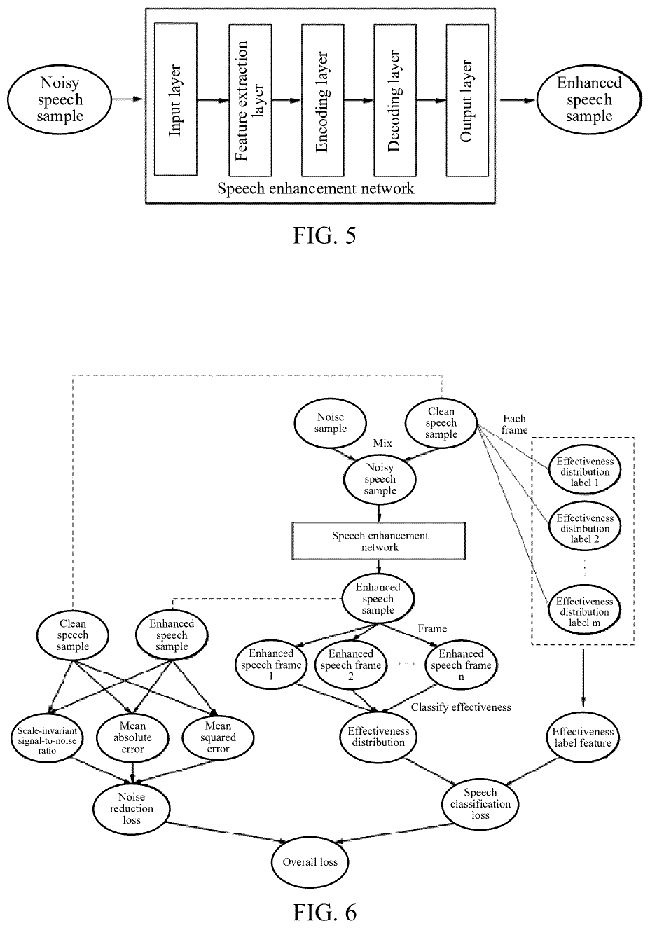

In some embodiments, with reference to FIG. 5, a structural diagram of a speech enhancement network acting based on an end-to-end model according to some embodiments is shown in FIG. 5. The end-to-end model is provided with an input layer, a feature extraction layer, an encoding layer, a decoding layer, and an output layer. During training, noisy speech sample may be input to the input layer as input of a network. Subsequently, the feature extraction layer performs feature extraction on the input through a series of convolution layers and pooling layers, to learn a local pattern and a spectrum feature in a speech signal, and forwards the local pattern and the spectrum feature to the encoding layer. The encoding layer encodes an input feature sequence through the recurrent neural network (such as the LSTM and the GRU) or the convolutional neural network, to capture context information and the time sequence relation, and outputs an encoded result to the decoding layer. The decoding layer decodes an encoded feature sequence through a reverse recurrent neural network or a convolutional neural network, and generates enhanced speech sample. Finally, the output layer performs post-processing (such as de-normalization and magnitude adjustment) on the speech signal output by the decoding layer, to obtain a final enhanced speech sample.

Operation 203: Frame the enhanced speech sample into a plurality of enhanced speech frames, classify speech effectiveness of each enhanced speech frame, and generate effectiveness distribution of the enhanced speech sample according to a classification result of each enhanced speech frame.

The enhanced speech frame is a speech segment obtained after the enhanced speech sample is framed. During speech signal processing, to perform effective feature extraction and processing, in some embodiments, longer enhanced speech sample is segmented into shorter consecutive segments, and these segments are referred to as the enhanced speech frames. By framing the enhanced speech sample into the plurality of enhanced speech frames, a long speech signal may be decomposed into a series of short-time speech frames. Each enhanced speech frame encompasses local information of the speech signal. Subsequent classification and evaluation of speech effectiveness of each enhanced speech frame are facilitated.

In some embodiments, a plurality of methods are available to frame the enhanced speech sample into the plurality of enhanced speech frames. For example, the enhanced speech signal is divided into frames having a fixed length at equal intervals by framing based on a fixed frame length. A frame length and a frame shift parameter are determined. For example, each frame has a signal length of 20 milliseconds, and adjacent frames are spaced at an interval of 10 milliseconds. Overlapping sampling is performed on the enhanced speech signal according to the frame shift length, and a consecutive frame sequence is obtained. Framing is performed through a sliding window. One sliding window may be used to slide on the speech signal and extract frames. A window length and a window movement step length are determined. The window length is identical to the frame length. The window slides according to the window movement step length from a starting position of the enhanced speech signal, to extract a signal in the window as one frame. Finally, the window continues to slide, to extract subsequent frames until the signal ends. Framing is performed through a dynamic energy threshold. A frame boundary may be determined according to an energy feature of a speech signal. Short-time energy of the enhanced speech signal is computed. The signal is framed, and energy of each frame is computed. One energy threshold is set, and configured for determining that a frame whose signal energy exceeds the threshold is taken as effective speech, and a frame whose signal energy is lower than the threshold is deemed as a mute sound or a background noise. Finally, an effective frame boundary in the enhanced speech signal is determined according to energy threshold inspection. The above framing method is not to limit a framing method in some embodiments. In some embodiments, proper framing methods may be selected under different scenarios and different application demand. The parameter may be adjusted according to an actual condition, to obtain an enhanced speech frame sequence satisfying the requirement.

The speech effectiveness indicates information about whether the enhanced speech frame encompasses an effective speech signal. The effective speech signal herein indicates an audio signal whose energy exceeds a preset energy threshold. The effective speech signal may be, for example, an effective human sound signal. An enhanced speech frame encompassing the effective speech signal essentially has strong energy, and the speech frame having the strong energy may be a clear human sound speech segment. Thus, the enhanced speech frame encompassing the effective speech signal may be correspondingly deemed as a speech segment encompassing the effective human sound signal. On the contrary, an enhanced speech frame encompassing no effective speech signal essentially has weak energy, and the speech frame having weak energy may be a noise speech segment. Thus, the enhanced speech frame encompassing no effective speech signal may be correspondingly deemed as a non-speech segment encompassing no effective human sound signal.

During speech signal processing in some embodiments, the speech effectiveness is classified to determine whether each enhanced speech frame belongs to the speech segment (for example, the speech segment encompassing the effective speech signal) or the non-speech segment (for example, the speech segment encompassing no effective speech signal). By classifying the speech effectiveness, if it is determined that an enhanced speech frame belongs to the speech segment, it indicates that the enhanced speech frame has effectiveness and belongs to the effective speech frame. On the contrary, by classifying the speech effectiveness, if it is determined that an enhanced speech frame belongs to the non-speech segment (for example, being the mute sound or the noise), it indicates that the enhanced speech frame has no effectiveness and does not belong to the effective speech frame. The speech effectiveness of each enhanced speech frame is classified, to identify the enhanced speech frame in which the effective speech signal (such as an effective human sound signal) is located, and thus various enhanced speech frames are classified.

Various non-speech segments, such as the muted sound and noise, exist in each enhanced speech frame. The speech effectiveness of each enhanced speech frame is classified, to determine the enhanced speech frames encompassing information about the effective speech signal, and thus the speech is distinguished from the non-speech. After the enhanced speech frames are classified into the speech segment and the non-speech segment, noises in the non-speech segment may be suppressed, and the frame in which the noises are located is recognized. Thus, the impact of the noise is further reduced, a speech enhancement effect may be improved, and subsequent model training is facilitated. By classifying the speech effectiveness of each enhanced speech frame, a starting position and an ending location of the speech segment may also be determined. Thus, the speech boundary is detected, which is crucial to speech recognition, and speech synthesis, for example, and is not limited herein.

The effectiveness distribution is a feature generated according to the effectiveness classification result of each enhanced speech frame, and configured for indicating which portions of the enhanced speech sample are the non-speech segments. For example, if the effectiveness classification result of an enhanced speech frame is that the enhanced speech frame belongs to the speech segment, the effectiveness classification result may be indicated as “1”, otherwise it may be indicated as “0”. Correspondingly, the effectiveness classification results of the plurality of enhanced speech frames may be combined into the effectiveness distribution, which may be, for example, “101010101010”. The effectiveness distribution may indicate which portions in the enhanced speech sample generated by the speech enhancement network are the non-speech segments. These features are crucial to effectiveness classification loss computation and training of the speech enhancement network, and can assist the network in better understanding and processing the non-speech segments. Thus, the speech enhancement quality may be improved, and the residual noises are reduced.

In some embodiments, speech effectiveness detection may be performed on the plurality of enhanced speech frames through short-time Fourier transform (STFT), a magnitude spectrum, a power spectrum, or a mel spectrum, for example. Through these frequency-domain representation methods, speech effectiveness detection may be performed on the plurality of enhanced speech frames, enhancement effects or qualities of the plurality of enhanced speech frames may be analyzed and compared, and finally the classification result of each enhanced speech frame may be obtained. This is not limited in some embodiments.

Operation 204: determine noise reduction accuracy of the speech enhancement network according to the enhanced speech sample and the clean speech sample; determine speech classification accuracy of the speech enhancement network according to the effectiveness distribution; determine the speech enhancement accuracy of the speech enhancement network according to the noise reduction accuracy and the speech classification accuracy; and train the speech enhancement network based on the speech enhancement accuracy.

The noise reduction accuracy is configured for measuring a difference between the enhanced speech sample processed by the speech enhancement network and the clean speech sample, and indicates an error or distortion degree generated when the enhanced speech sample is generated by the speech enhancement network by performing the noise reduction on the noisy speech sample. The noise reduction accuracy indicates the noise reduction accuracy of the speech enhancement network on the noisy speech sample. The noise reduction accuracy may be embodied according to the difference between the enhanced speech sample obtained through noise reduction and the clean speech sample without being mixed with the noise sample. By computing the difference between the enhanced speech sample and the clean speech sample, a noise reduction effect and a capability of the speech enhancement network to convert the signal can be reflected.

In some embodiments, a noise reduction loss of the speech enhancement network may be determined according to the enhanced speech sample and the clean speech sample through a plurality of methods. The noise reduction loss may correspondingly indicate the above noise reduction accuracy. For example, the noise reduction loss may be computed through a mean squared error loss. The mean squared error loss is a common indicator for evaluating a difference between a generated result and a target result. By minimizing the noise reduction loss, the error or distortion generated when the speech enhancement network converts the noisy speech sample into the enhanced speech sample. In a training process, the noise reduction loss is gradually reduced and the parameter of the speech enhancement network is updated through a gradient descent method, for example, so that the speech enhancement network is gradually optimized and approaches an optimal state. Through a plurality of iterative training, the speech enhancement network may gradually learn a mapping relation between the clean speech sample and the enhanced speech sample, to improve the noise reduction effect. The noise reduction loss is in a negative correlation with the noise reduction accuracy. The higher the noise reduction accuracy is, the smaller the noise reduction loss is.

The noise reduction accuracy takes into account only the difference between the clean speech sample and the enhanced speech sample, and has the limitation when a processing effect of the speech enhancement network on the non-speech segment is measured. To evaluate performance of the speech enhancement network more comprehensively, the speech enhancement accuracy may be determined with reference to speech classification accuracy, so that network training is further optimized.

The speech classification accuracy is configured to measure classification accuracy of the speech enhancement network on the speech segment (the speech segment including the effective speech signal) and the non-speech segment (the speech segment including no effective speech signal) in the noisy speech sample in a speech enhancement process. The speech classification accuracy obtained based on the effectiveness distribution configured for indicating a distribution condition of the speech segment and the non-speech segment in the enhanced speech sample may measure a recognition effect and a processing effect of the speech enhancement network on the non-speech segment. The speech classification loss may be determined according to a difference between speech effectiveness of the enhanced speech frame generated and each clean speech frame in the clean speech sample. The speech classification loss may correspondingly reflect the above speech classification accuracy. The speech classification loss is configured for indicating an error generated when the speech enhancement network classifies effectiveness of the speech frame in the noisy speech sample. The speech enhancement network is trained with reference to the speech classification loss. Thus, the speech enhancement network can better suppress noises in the non-speech segment, and the noise reduction effect and the quality of the enhanced speech generated can be improved. The speech classification loss can assist the network in learning more accurate speech/non-speech classification, so that residual noises can be avoided. The speech classification loss is in a negative correlation with the speech classification accuracy. The higher the speech classification accuracy is, the smaller the speech classification loss is.

In some embodiments, the speech classification loss of the speech enhancement network may be determined according to the effectiveness distribution through a plurality of methods. The speech classification loss of the speech enhancement network may be computed through a metric method, such as a cross entropy loss and a mean squared error loss, which is not limited herein.

In some embodiments, the speech enhancement accuracy of the speech enhancement network may be determined by combining the noise reduction accuracy and the speech classification accuracy. The above noise reduction loss and speech classification loss are combined to determine an overall loss configured for reflecting the speech enhancement accuracy of the speech enhancement network. The speech enhancement accuracy takes into account the impact of the speech enhancement network on a sound quality and speech effectiveness of the enhanced speech frame comprehensively. An optimization direction of the speech enhancement network in a training process is determined, and the performance of the network is more optimized in the training process. The overall loss is also in a negative correlation with the speech enhancement accuracy. The higher the speech enhancement accuracy is, the smaller the overall loss is.

In some embodiments, the noise reduction loss and the speech classification loss may be added according to a particular weight, and a final overall loss may be obtained. In the training process, the overall loss is taken as a target function for optimization. The parameter of the speech enhancement network is updated through a back propagation algorithm. Thus, the overall loss is reduced. The overall loss determined according to the noise reduction loss and the speech classification loss may be minimized through the gradient descent method, for example. Iterative training is performed according to training data, to continuously enhance the performance of the speech enhancement network, and improve a capability of the speech enhancement network to suppress the noises in the non-speech segment. When noise reduction is performed on a to-be-processed speech based on the trained speech enhancement network, for the to-be-processed speech encompassing the non-speech segment, the trained speech enhancement network can effectively reduce the residual noises, so that the speech enhancement quality can be improved.

In some embodiments, the enhanced speech sample is framed into the plurality of enhanced speech frames, the speech effectiveness of each enhanced speech frame is classified, and the effectiveness distribution of the enhanced speech sample is generated according to the classification result of each enhanced speech frame. Since the effectiveness distribution may indicate whether each enhanced speech frame generated by the speech enhancement network is the non-speech segment, the recognition accuracy of the currently-trained speech enhancement network on the speech segment (for example, the speech signal encompassing the effective human sound) and the non-speech segment (for example, the speech signal encompassing no effective human sound, such as a mute signal and a noise signal) may be measured through the speech classification accuracy of the speech enhancement network determined through the effectiveness distribution. The speech enhancement accuracy of the speech enhancement network is determined according to the noise reduction accuracy and the speech classification accuracy, and the speech enhancement network is trained based on the speech enhancement accuracy, so that the capability of the speech enhancement network to recognize the speech segment and the non-speech segment can be improved, and correspondingly, the capability to suppress the noises in the non-speech segment can be emphatically improved. When the noise reduction on the to-be-processed speech is performed based on the trained speech enhancement network, for the to-be-processed speech encompassing the non-speech segment, the trained speech enhancement network can effectively reduce the residual noises in the non-speech segment, and thus the speech enhancement quality can be improved.

In some embodiments, the speech effectiveness of each enhanced speech frame is classified according to a time-domain energy parameter of the enhanced speech frame. A process of classifying the speech effectiveness in the above operation 203 is described below.

In some embodiments, the speech effectiveness of each enhanced speech frame may be classified according to the time-domain energy parameter. A time-domain energy parameter of each enhanced speech frame is determined, the time-domain energy parameter being configured for indicating speech energy magnitude of the enhanced speech frame in the time domain; and the speech effectiveness of each enhanced speech frame is classified according to the time-domain energy parameter and a preset energy threshold.

The time-domain energy parameter is a parameter configured for indicating the speech energy magnitude of the enhanced speech frame in the time domain, and the time-domain energy is a result of computing energy the speech signal in time. A plurality of methods are available to determine the time-domain energy parameter of each enhanced speech frame. For example, the time-domain energy parameter may be obtained by computing the squaring sum of sample values in the speech frame through a short-time energy method. For a given speech frame, a sample value of the speech frame is deemed as one vector, and the squaring sum of the vector is computed as the energy parameter. The energy parameter may be computed by analyzing the speech signal in the frequency domain through a short-time magnitude spectrum method. Fourier transform is performed on the speech frame, and a short-time magnitude spectrum is obtained. The short-time magnitude spectrum undergoes a squaring operation and accumulation, and the time-domain energy parameter is obtained. The energy parameter may be computed through an autocorrelation method according to an autocorrelation function of the speech signal. The autocorrelation function reflects a similarity between the signal and the signal itself at different time points. The time-domain energy parameter may be obtained by computing a peak value or an area of the autocorrelation function. The speech frame may be analyzed through a wavelet transform method according to wavelet transform, energy information may be extracted from a wavelet coefficient, and the time-domain energy parameter may be obtained. The process of obtaining the time-domain energy parameter is not limited in some embodiments.

In some embodiments, the speech effectiveness of each enhanced speech frame may be classified according to the time-domain energy parameter and the preset energy threshold. The preset energy threshold, a threshold preset or determined through experiments in some embodiments, is configured for determining whether the energy of the speech frame satisfies a limit value of an effectiveness requirement. The time-domain energy parameter of each enhanced speech frame may be compared with the preset energy threshold. If the time-domain energy parameter of the enhanced speech frame is greater than the preset energy threshold, the enhanced speech frame is deemed as the effective speech frame. On the contrary, if the time-domain energy parameter of the speech frame is lower than the preset energy threshold, the speech frame is deemed as the non-speech frame or the noise frame.

The time-domain energy parameter includes single-frame mean energy. The speech effectiveness of each enhanced speech frame may be classified by comparing the single-frame mean energy with comprehensive mean energy of the clean speech sample. The comprehensive mean energy of the clean speech sample is determined, and weighted according to the preset energy threshold, and weighted mean energy is obtained; when the single-frame mean energy is greater than the weighted mean energy, it is determined that the classification result of the speech effectiveness of the enhanced speech frame is that the enhanced speech frame belongs to the effective speech frame; or when the single-frame mean energy is less than or equal to the weighted mean energy, it is determined that the classification result of the speech effectiveness of the enhanced speech frame is that the enhanced speech frame does not belong to the effective speech frame.

In some embodiments, the single-frame mean energy indicates mean energy magnitude of the sample values in one speech frame. In some embodiments, the squaring sum of the sample values in the speech frame may be computed to indicate the energy. The squaring operation is performed on sample values of each speech frame, the sum is computed, and the single-frame mean energy configured for indicating the energy of the speech frame is obtained. Overall energy in the speech frame may be evaluated through the single-frame mean energy. In some embodiments, with the time-domain energy parameter being the single-frame mean energy as an example, on the premise that the requirement in some embodiments is satisfied, a single-frame energy median or a single-frame energy maximum in a single-frame energy value may be selected as the time-domain energy parameter, which is not limited.

In some embodiments, the comprehensive mean energy, an energy metric for the clean speech sample, is one parameter configured for performing energy computation and classification on the clean speech sample. In some embodiments, since the clean speech sample encompasses no non-speech segment or noises, the comprehensive mean energy may indicate mean energy magnitude of each frame in the speech.

In some embodiments, to better adapt to speech characteristics under different environments, the comprehensive mean energy is weighted according to the preset energy threshold, to obtain the weighted mean energy. The preset energy threshold, one reference value set according to actual application demand and empirical knowledge can reflect a typical energy range of the effective speech. By weighting the comprehensive mean energy, a reference energy parameter for a particular environment and configured for measuring effectiveness of the speech frame may be obtained. In an actual scenario, the speech signal may be disturbed by noises. The comprehensive mean energy of the clean speech sample may be adjusted through the preset energy threshold, to obtain the weighted mean energy for determining speech characteristics under different noise environments. For example, when the environment noises are strong, the preset energy threshold may be correspondingly increased. The enhanced speech frame encompassing the effective speech may be more likely to be classified as the effective frame. Energy of the speech signal probably fluctuates greatly in time. The energy characteristics of an entire speech segment can be considered through the weighted mean energy, to better capture a dynamic change of the speech signal. Through the weighted mean energy, a fluctuation magnitude of the energy of single speech frame can be reduced, so that a classification result is more stable and reliable. By weighting the comprehensive mean energy according to the preset energy threshold, the accuracy and robustness for determining the speech effectiveness of the enhanced speech frame can be improved, and different noise environments and different speech signal change conditions can be better adapted to. Thus, a more reliable speech enhancement effect can be achieved.

In some embodiments, since the enhanced speech sample is framed into the plurality of enhanced speech frames, if no non-speech segment or noise exists in these enhanced speech frames, energy of the current enhanced speech frame is greater than overall mean energy in the presence of other non-speech segments or noises. Other non-speech segments or noises may lower the overall mean energy. On the contrary, if the non-speech segments or noises exist in the enhanced speech frame, energy of the current frame is lowered in the presence of these non-speech segments or noises. Whether the enhanced speech frame encompasses the effective speech may be determined by comparing the single-frame mean energy with the weighted mean energy. If the single-frame mean energy is greater than the weighted mean energy, it indicates that energy of the enhanced speech frame is greater than mean energy of the clean speech. Thus, it may be determined that the classification result of the speech effectiveness of the enhanced speech frame is that the enhanced speech frame belongs to the effective speech frame. On the contrary, if the single-frame mean energy is less than or equal to the weighted mean energy, it indicates that energy of the enhanced speech frame is low. Thus, it may be determined that the classification result of the speech effectiveness of the enhanced speech frame is that the enhanced speech frame does not belong to the effective speech frame.

A process of determining whether the enhanced speech frame belongs to the effective speech frame according to the single-frame mean energy is described in detail below with reference to the embodiment.

A frame-level speech effectiveness determination method is provided in some embodiments. Assuming that the clean speech sample signal sₙ, n=1, 2, 3 . . . N is a 48 kHz discrete-time sampling signal, some segments of the signal belong to the non-speech segment, for example, a segment in which no person speaks. Such segments have low energy, and thus may even be deemed as mute segments. In some embodiments, the enhanced speech sample is framed according to a fixed frame length and a frame shift (1024, 512). This indicates that the speech is divided into the plurality of frames, each frame encompasses 1024 sampling points, and adjacent frames have 512 sampling points that overlap. The process of framing the enhanced speech sample is similar to the above framing. In the enhanced speech signal s_{i,j}, i=1, 2, . . .

$$\frac{N}{1024}$$

denotes a frame ordinal number after sₙ is framed, j denotes a j^{th} sampling point of an i^{th} signal, and N denotes a frame number. Thus,
the comprehensive mean energy Pₛ of the clean speech sample is

$${P}_{s} = \frac{1}{N} {\sum }_{n = 1}^{N} {s}_{n}^{2} ;$$

the single-frame mean energy Pᵢ is

$${P}_{i} = \frac{1}{1024} {\sum }_{j = 1}^{1024} {s}_{i , j}^{2} ;$$

and
the preset energy threshold ε=0.01.

The preset energy threshold ε may be set to other values in addition to 0.01. The value may be obtained according to an experiment, and adjusted according to a training effect of the network.

Thus, the comprehensive mean energy is weighted according to the preset energy threshold, to obtain the weighted mean energy Pₛ·ε. Thus, the classification result of the speech effectiveness of the enhanced speech frame is as follows:

$${V}_{i} = \{ \begin{matrix}1 , & if {P}_{i} > {P}_{s} \cdot ε \\ 0 , & else\end{matrix}$$

By comparing the single-frame mean energy with the weighted mean energy, whether the frame signal belongs to the effective speech segment can be determined, so that the determination accuracy is high. When the single-frame mean energy is greater than the weighted mean energy, Vᵢ equals 1, indicating that the enhanced speech frame belongs to the effective speech frame. On the contrary, if the single-frame mean energy is less than or equal to the weighted mean energy, Vᵢ equals 0, indicating that the enhanced speech frame does not belong to the effective speech frame. The classification result of the speech effectiveness of the enhanced speech frame may be determined through Vᵢ.

Based on the above flow, the simplified representation of a classification result

$${V}_{s}^{i}$$

of the speech effectiveness of each enhanced speech frame is as follows:

$${V}_{s}^{i} = ℱ ( {s}_{n} )$$

The classification result

$${V}_{s}^{i}$$

of the speech effectiveness of each enhanced speech frame may be written as V_{s,i} or Vᵢₛ, indicating a classification result of speech effectiveness of an i^{th} enhanced speech frame.

In the above implementation, the comprehensive mean energy of the clean speech sample is weighted through the preset energy threshold, and the weighted mean energy is obtained. Thus, a corresponding speech effectiveness determination threshold can be set to better adapt to different noise environments and different speech signal change conditions. Whether the enhanced speech frame belongs to the effective speech frame is determined by determining whether the single-frame mean energy of the enhanced speech frame is greater than the weighted mean energy. Thus, the accuracy and robustness for determining the speech effectiveness of the enhanced speech frame may be improved.

In the above embodiment, the process of determining whether the enhanced speech frame belongs to the effective speech frame according to the single-frame mean energy computed in some embodiments is described. The process of computing the single-frame short-time energy of the enhanced speech frame, and determining whether the enhanced speech frame is the effective speech frame according to the single-frame short-time energy is further performed in some embodiments. The process of determining whether the enhanced speech frame is the effective speech frame according to the single-frame short-time energy is described below.

The time-domain energy parameter may further include single-frame short-time energy. A plurality of preset energy thresholds may be provided. The plurality of preset energy thresholds include a first energy threshold and a second energy threshold. The first energy threshold is greater than the second energy threshold. Thus, the speech effectiveness of each enhanced speech frame may be classified by comparing the single-frame short-time energy with at least one of the first energy threshold and the second energy threshold. When the single-frame short-time energy is greater than the first energy threshold, it is determined that the classification result of the speech effectiveness of the enhanced speech frame is that the enhanced speech frame belongs to the effective speech frame; or when the single-frame short-time energy is less than or equal to the second energy threshold, it is determined that the classification result of the speech effectiveness of the enhanced speech frame is that the enhanced speech frame does not belong to the effective speech frame.

The single-frame short-time energy indicates short-time energy of each enhanced speech frame. The short-time energy, an indicator configured for measuring local energy of the speech or the audio signal, may be obtained by computing energy of each frame of the signal. The short-time energy is computed to reflect an energy change of the speech or the audio signal in short time. In a segment with strong sounds, a short-time energy value is high, and in a segment with mute sounds or low sounds, a short-time energy value is low.

The single-frame short-time energy may be computed in a magnitude square mode. For example, a squaring operation is performed on sampling points of each enhanced speech frame, results are accumulated, and normalization is performed when necessary, to obtain the single-frame short-time energy. Thus, a number of the single-frame short-time energy is related to the sampling points. The short-time energy of each frame may be computed with reference to a proper frame length and a proper frame shift parameter. The frame length determines a number of sampling points encompassed in each frame, and the frame shift indicates a number of overlapping points between adjacent frames. Such framing may divide the speech or the audio signal into a plurality of local segments, so that the short-time energy change of the signal can be better captured.

In some embodiments, the first energy threshold and the second energy threshold, two preset energy thresholds, are configured for determining whether each enhanced speech frame belongs to the effective speech frame based on single-frame short-time energy magnitude of each enhanced speech frame. The first energy threshold is greater than the second energy threshold. The first energy threshold is a set threshold indicating that short-time energy is large to a given extent (indicating that short-time energy is strong). When the single-frame short-time energy is greater than the first energy threshold, it indicates that the single-frame short-time energy is large enough, and sounds in the frame are strong. If the single-frame short-time energy of the enhanced speech frame is greater than the first energy threshold, it may be determined that the classification result of the speech effectiveness of the enhanced speech frame is that the enhanced speech frame belongs to the effective speech frame. On the contrary, the second energy threshold is a set threshold indicating that short-time energy is small to a given extent (indicating that short-time energy is low). When the single-frame short-time energy is less than or equal to the second energy threshold, it indicates that the single-frame short-time energy is small enough, sounds in the frame are low, and it is less likely to generate effective sounds. If the single-frame short-time energy of the enhanced speech frame is less than the second energy threshold, it may be determined that the classification result of the speech effectiveness of the enhanced speech frame is that the enhanced speech frame does not belong to the effective speech frame. If the single-frame short-time energy is between the first energy threshold and the second energy threshold, further determination may be performed.

In some embodiments, when the single-frame short-time energy is less than or equal to the first energy threshold and greater than the second energy threshold, by comparing a short-time mean zero-crossing rate of the enhanced speech frame with a preset zero-crossing rate threshold, the speech effectiveness of each enhanced speech frame is classified. When the single-frame short-time energy is less than or equal to the first energy threshold and greater than the second energy threshold, the short-time mean zero-crossing rate of the enhanced speech frame is acquired. When the short-time mean zero-crossing rate is greater than the preset zero-crossing rate threshold, it is determined that the classification result of the speech effectiveness of the enhanced speech frame is that the enhanced speech frame belongs to the effective speech frame. When the single-frame short-time energy is less than or equal to the first energy threshold and greater than the second energy threshold, the short-time mean zero-crossing rate of the enhanced speech frame is acquired. When the short-time mean zero-crossing rate is less than or equal to a preset zero-crossing rate threshold, it is determined that the classification result of the speech effectiveness of the enhanced speech frame is that the enhanced speech frame does not belong to the effective speech frame.

In some embodiments, the short-time mean zero-crossing rate is configured for describing a frequency at which a signal crosses a zero point in short time. The zero point herein is a point having zero energy. During voice activity detection, the short-time mean zero-crossing rate may assist in distinguishing the speech segment from the non-speech segment. The speech segment has a higher short-time mean zero-crossing rate. Since a vocal cord vibration frequency is higher during articulation, positive and negative zero-crossing frequencies are higher. The non-speech segment lacks a sound signal, and thus has a lower short-time mean zero-crossing rate.

In some embodiments, the short-time mean zero-crossing rate is computed by determining sampling points of each frame, to determine whether positive or negative zero-crossing occurs. When the signal changes from a positive value to a negative value or from a negative value to a positive value, zero-crossing occurs once. The short-time mean zero-crossing rate indicates a number of zero-crossing occurring in each sample on average within a period of time. For computing the short-time mean zero-crossing rate of each frame, a sampling point of the frame may be compared with a previous sampling point, and whether zero-crossing occurs is detected. A number of zero-crossing occurring in each frame is accumulated, and normalization is performed.

In some embodiments, when the short-time mean zero-crossing rate is higher, it indicates that a change frequency in the signal is higher. A number by which the signal waveform crosses the zero point in short time is larger, it indicates that the signal encompasses more high-frequency components or rapidly-changing audio contents. Thus, the signal has a higher probability of being an effective speech encompassing the speech segment. On the contrary, if the short-time mean zero-crossing rate is lower, it indicates that a change frequency in the signal is lower, the waveform is stable, and a number of zero-crossing is smaller. Thus, the signal encompasses more low-frequency components or stable audio contents. The signal having a lower short-time mean zero-crossing rate probably includes the non-speech segment, noises, for example.

In some embodiments, the preset zero-crossing rate threshold is a preset threshold configured for evaluating the short-time mean zero-crossing rate in some embodiments. The preset zero-crossing rate threshold may be determined through experiments and experience, and adjusted according to a training condition in a training process. In some embodiments, the preset zero-crossing rate threshold may be adjusted according to the conditions and demand, and evaluation on the short-time mean zero-crossing rate is probably different under different application scenarios. Thus, the preset zero-crossing rate threshold is probably different.

In some embodiments, when the single-frame short-time energy is less than or equal to the first energy threshold and greater than the second energy threshold, a short-time mean zero-crossing rate of the enhanced speech frame may be acquired, the effectiveness is determined through the short-time mean zero-crossing rate. When the short-time mean zero-crossing rate is greater than the preset zero-crossing rate threshold, it is determined that the classification result of the speech effectiveness of the enhanced speech frame is that the enhanced speech frame belongs to the effective speech frame. On the contrary, when the short-time mean zero-crossing rate is less than or equal to the preset zero-crossing rate threshold, it is determined that the classification result of the speech effectiveness of the enhanced speech frame is that the enhanced speech frame does not belong to the effective speech frame.

The single-frame short-time energy is compared with the first energy threshold and the second energy threshold separately; and the short-time mean zero-crossing rate is compared with the preset zero-crossing rate threshold when the single-frame short-time energy is between the first energy threshold and the second energy threshold, which belongs to the double-threshold method used in some embodiments. Through the double-threshold method, the classification result of the speech effectiveness of the enhanced speech frame can be effectively determined in some embodiments.

In some embodiments, the classification result of the speech effectiveness of the enhanced speech frame may be determined through an autocorrelation method, a spectral entropy method, a ratio method, or a logarithmic spectral distance method.

In some embodiments, the classification result of the speech effectiveness of the enhanced speech frame may be determined through a short-time autocorrelation method. An autocorrelation function may be determined. The autocorrelation function has some properties. For example, if the autocorrelation function is an even function, assuming that a sequence has periodicity, the autocorrelation function is also a periodic function having the same period. In some embodiments, discrete sampling points of a speech signal waveform on the enhanced speech frame may be acquired, and input to the autocorrelation function according to a preset number of delay points, and an autocorrelation value of the enhanced speech frame may be computed. To avoid the impact of absolute energy in the process, normalization also may be performed on a current autocorrelation value according to an autocorrelation value at a signal inspiration moment.

A plurality of methods are available to determine the classification result of the speech effectiveness of the enhanced speech frame through the autocorrelation function. For example, a pitch period of a speech waveform sequence may be extracted by computing the autocorrelation function of the speech signal. The pitch period, one important feature of the speech signal, is crucial to speech recognition and acoustic modeling. The pitch period of the speech waveform sequence indicates a time interval at which a pitch repeats between consecutive speech frames. If extraction of the pitch period succeeds, in some embodiments, it may be determined that sound vibration in the enhanced speech signal has periodicity. This indicates that the speech signal probably encompasses effective speech information. Due to a difference between an autocorrelation function of the speech signal and the autocorrelation function of the noise signal, the speech signal may be distinguished from the noise signal through such a difference, and thus speech endpoint detection is effectively performed. When a maximum of the autocorrelation function, for example, a maximum autocorrelation value exceeds a particular autocorrelation threshold, it may be determined that the enhanced speech frame belongs to the effective speech frame. A starting point and an ending point of the speech signal may be determined through an autocorrelation function maximum method. When the maximum of the autocorrelation function is greater than or less than a set threshold, an endpoint of the speech signal may be determined. Since the speech signal has higher energy and more spectrum information, compared with the noise signal, the starting point and the ending point of the speech signal after endpoint detection may present different characteristics. The speech effectiveness may be further determined according to the determined endpoint of the speech signal. The speech signal encompasses effective speech information within the period of time.

In some embodiments, the classification result of the speech effectiveness of the enhanced speech frame may be determined through the spectral entropy method. The entropy indicates an order degree of information. In the information theory, the entropy describes the indeterminacy of a random event result. Information entropy is taken as a measure of information selection and indeterminacy for a signal transmitted from one information source. There is a big difference between speech entropy and noise entropy. The feature of the spectral entropy is exemplary, and indicates a distribution probability of the speech and the noise in an entire signal segment.

In some embodiments, windowing and framing and FFT may be performed on the enhanced speech frame, and spectral information of each frame may be obtained. Subsequently, a spectral entropy value is computed for the spectral information of each frame, and a spectral entropy sequence is obtained. According to statistical characteristics of the spectral entropy sequence, a proper threshold is determined as a standard for determining speech signal effectiveness. The spectral entropy sequence is binarized according to the threshold, the part greater than the threshold is marked as the speech segment, and the part less than the threshold is marked as the non-speech segment. Thus, the classification result of the speech effectiveness of the enhanced speech frame can be determined.

In some embodiments, the classification result of the speech effectiveness of the enhanced speech frame may be determined through the energy entropy ratio. Such a ratio is the energy entropy ratio. The spectral entropy, a type of statistical feature of the speech signal spectrum, can reflect complexity and spectral distribution uniformity of the speech signal. In the speech segment, since spectral distribution of a human sound is uniform and complex, the spectral entropy value is small. In the noise segment, since the spectral distribution of noises is non-uniform and simple, the spectral entropy value is large. Thus, the speech segment can be well distinguished from the noise segment by comparing the spectral entropy values. In some embodiments, by computing the energy entropy ratio, for example, a ratio of the energy entropy of the current frame to the energy entropy of the noise segment, the difference between the speech segment and the noise segment can be further highlighted. In the speech segment, the energy entropy is higher. In the noise segment, the energy entropy is lower. Thus, by setting a proper energy entropy ratio threshold, the part whose energy entropy ratio is greater than the threshold may be determined as the speech segment. Thus, the speech effectiveness is determined.

In some embodiments, spectral information of the enhanced speech frame may be computed. A spectral entropy value is computed for the spectrum information of each frame, and a spectral entropy sequence is obtained. Subsequently, a spectral entropy value of the speech segment and a spectral entropy value of the noise segment are computed, or obtained through statistics on a training sample set or experience. An energy entropy ratio of the enhanced speech frame is computed, and a proper threshold is set. The part greater than the threshold is marked as the speech segment, and the part less than the threshold is marked as the non-speech segment. Thus, the classification result of the speech effectiveness of the enhanced speech frame is obtained.

In some embodiments, the classification result of the speech effectiveness of the enhanced speech frame may be determined through the logarithmic spectral distance. In some embodiments, the FFT may be performed on each speech signal, and a logarithmic spectral distance of the speech signal is computed, to measure the speech quality. Thus, the signal effectiveness is determined. The logarithmic spectral distance determines the signal effectiveness by comparing a distance between a logarithmic spectrum of each speech signal and a mean noise spectrum. In the speech frame, energy of the speech signal has a higher logarithmic spectral value. In the noise frame, energy of the noise signal is low, and has a smaller logarithmic spectral value. Thus, the speech frame can be well distinguished from the noise frame by computing the logarithmic spectral distance. The logarithmic spectral distance utilizes a statistical feature of the speech signal in a frequency domain. The speech signal has a particular spectral distribution rule. A spectrum of the noise signal is more chaotic. By computing the logarithmic spectral distance, the difference between the speech and the noise can be quantized, so that the speech effectiveness can be determined.

Reference can be made to a mean noise spectrum during computation of the logarithmic spectral distance. With the mean noise spectrum, the impact of noises on speech recognition can be suppressed, so that the logarithmic spectral distance can reflect a speech quality more accurately. Since the noise features non-uniform spectral distribution and simplicity, the feature of the speech signal can be better extracted through comparison with the mean noise spectrum.

In some embodiments, spectral information of the enhanced speech frame may be computed, a modulus value of the spectrum is obtained, and then a logarithm is computed, and a logarithm spectrum is obtained. The logarithm spectral distance between each logarithm spectrum and the mean noise spectrum is computed, and a proper threshold is set according to experience or an experimental result, to determine the distinctiveness between the speech frame and the noise frame. The part greater than the threshold is marked as the speech frame, and the part less than the threshold is marked as the non-speech segment. Thus, the classification result of the speech effectiveness of the enhanced speech frame is obtained.

Compared with several methods for determining the classification result of the speech effectiveness of the enhanced speech frame, the classification result of the speech effectiveness of the enhanced speech frame can be more intuitively determined based on the time-domain energy parameter. Efficiency of determining the classification result of the speech effectiveness can be effectively improved.

In some embodiments, the speech classification accuracy of the speech enhancement network may be determined through a plurality of methods. A process of determining the speech classification accuracy of the speech enhancement network in operation 204 is described below.

In some embodiments, the speech classification accuracy of the speech enhancement network may be computed through an effectiveness distribution label. An effectiveness distribution label configured for indicating speech effectiveness of each frame in the clean speech sample is acquired; and the speech classification accuracy of the speech enhancement network is determined according to a similarity between the effectiveness distribution and the effectiveness distribution label.

In some embodiments, the effectiveness distribution label, configured for indicating the speech effectiveness of each frame in the clean speech sample, may indicate whether each speech frame in the clean speech sample encompasses the speech signal (having effectiveness) or the non-speech signal (having no effectiveness). The speech enhancement network may measure a speech enhancement effect according to the effectiveness distribution label in the training process, and compute a speech classification loss. In combination with the effectiveness distribution, the effectiveness distribution label can assist the speech enhancement network in learning to correctly classify the speech portion and the non-speech portion in the noisy speech, so that residual noises can be reduced. The speech classification loss is determined according to the similarity between the effectiveness distribution and the effectiveness distribution label. In some embodiments, the speech classification loss may be computed through a plurality of methods. By minimizing the speech classification loss, the speech enhancement network can better suppress noises in the non-speech segment, and improve the speech enhancement quality. The speech enhancement network can more accurately determine the speech portion and the non-speech portion, so that clearer and more natural target enhanced speech can be generated.

In some embodiments, a mean absolute error, a mean squared error, and binary cross entropy may be computed, to measure the similarity between the effectiveness distribution and the effectiveness distribution label. Thus, the speech classification loss of the speech enhancement network is determined. Binary cross entropy between the effectiveness distribution and the effectiveness label feature, a mean absolute error between the effectiveness distribution and the effectiveness label feature, and a mean squared error between the effectiveness distribution and the effectiveness label feature are determined; and the binary cross entropy, the mean absolute error, and the mean squared error are weighted, and the speech classification loss of the speech enhancement network is obtained.

In some embodiments, an effectiveness label feature is obtained according to the effectiveness distribution label, and corresponds to the effectiveness distribution. Since the sample has the effectiveness distribution label configured for indicating the effectiveness of each speech frame in the clean speech sample, effectiveness distribution labels of all frames of the clean speech sample are combined to form the effectiveness label feature. The effectiveness distribution is generated according to the classification result of each enhanced speech frame. The classification result of each enhanced speech frame indicates a classification condition of each frame. The classification conditions of all enhanced speech sample frames are combined to form the effectiveness distribution.

In some embodiments, a mean absolute error between the effectiveness distribution and the effectiveness label feature, for example, an L1 loss, is recorded as L1ᵥ. A mean value of absolute differences between the effectiveness distribution and the effectiveness label feature may be computed to obtain a mean absolute error.

In some embodiments, a mean squared error between the effectiveness distribution and the effectiveness label feature, for example, an L2 loss, is recorded as L2ᵥ. A square of a difference between each of two pieces of effectiveness distribution and the effectiveness label feature may be computed, and then a mean value of the squares of the differences is computed, and a mean squared error is obtained.

In some embodiments, binary cross entropy (BCE) between the effectiveness distribution and the effectiveness label feature, for example, a BCE loss, is recorded as L_{BCE}. The cross entropy between the effectiveness distribution and the effectiveness label feature may be computed. The binary cross entropy L_{BCE} in some embodiments may be obtained according to a formula as follows:

$${L}_{BCE} = - [ p \times log q + ( 1 - p ) \times log ( 1 - q ) ]$$

In the formula, p denotes a classification result in the effectiveness label feature Vₛ, and q denotes a classification result in the effectiveness distribution V_{\tilde{s}}. When the frame signal indicated has effectiveness, p and q equal 1, p and q equal 0.

Finally, in some embodiments, the speech classification loss Lᵥ(Vₛ, V_{\tilde{s}}) may be obtained as follows:

$${L}_{v} ( {V}_{s} , {V}_{\tilde{s}} ) = {K}_{1} L {1}_{v} + {K}_{2} L {2}_{v} + {K}_{3} {L}_{BCE}$$

In the formula, K₁ denotes a coefficient of the L1 loss, K₂ denotes a coefficient of the L2 loss, and K₃ denotes a coefficient of the BCE loss.

In some embodiments, the speech classification accuracy of the speech enhancement network is computed through the effectiveness classification label configured for indicating the speech effectiveness of each frame in the clean speech sample, which can assist the speech enhancement network in learning to correctly classify the speech portion and the non-speech portion in the noisy speech. Thus, the residual noises are reduced, and the speech enhancement quality may be improved. The speech enhancement network can determine the speech portion and the non-speech portion more accurately, and a clearer and more natural target enhanced speech is generated.

In some embodiments, the speech classification accuracy of the speech enhancement network may be determined by comparing the loss. A distribution similarity between effectiveness distribution corresponding to two enhanced speech samples having a correspondence relation is determined. The two enhanced speech samples having a correspondence relation are obtained by performing, based on the speech enhancement network, noise reduction on two noisy speech samples included in a speech sample pair respectively. The two noisy speech samples included in the speech sample pair are generated based on the same clean speech sample. The speech classification accuracy of the speech enhancement network is determined according to the distribution similarity.

In some embodiments, the distribution similarity is an index configured for measuring a similarity between two pieces of effectiveness distribution, and the speech sample pair indicates two noisy speech samples obtained by mixing the same clean speech sample with different noise samples. When the speech classification loss configured for indicating the speech classification accuracy of the speech enhancement network is determined, the distribution similarity between effectiveness distribution of the two enhanced speech samples obtained by performing noise reduction on the two noisy speech samples in the speech sample pair may be computed. For example, the distribution similarity is computed through a cosine similarity or a Euclidean distance. By comparing the effectiveness distribution of the two enhanced speech samples, one distribution similarity value may be obtained to measure whether effectiveness of the two enhanced speech samples is similar, to determine a comparison loss functioning as the speech classification loss of the speech enhancement network accordingly. The speech enhancement network is trained by minimizing the loss, so that a noise reduction effect and speech intelligibility may be improved.

In some embodiments, in a process of determining the speech classification loss of the speech enhancement network through the comparison loss, the two noisy speech samples obtained by mixing the same clean speech sample may be configured as the speech sample pair. Noise reduction is performed on the two noisy speech samples in the speech sample pair through the speech enhancement network separately, and the two enhanced speech samples are obtained. Each enhanced speech sample is framed, and the speech effectiveness of each enhanced speech frame is classified, and the effectiveness distribution of each enhanced speech sample is generated according to the classification result. The distribution similarity between the effectiveness distribution of the two enhanced speech samples is computed through the cosine similarity or the Euclidean distance, for example. Finally, the speech classification loss of the speech enhancement network is determined based on the distribution similarity. The higher the distribution similarity is, the higher the similarity of the effectiveness of the two enhanced speech samples is, and the better the noise reduction effect of the speech enhancement network is. Thus, the distribution similarity may be taken as part of the speech classification loss.

In the above implementation, by comparing the loss, the distribution similarity between the effectiveness distribution respectively corresponding to the two enhanced speech samples having a correspondence relation is computed, and the speech classification accuracy of the speech enhancement network is determined according to the distribution similarity. The speech enhancement network is trained based on the speech classification accuracy, which assists the speech enhancement network in learning to accurately determine the speech portion and the non-speech portion. Thus, the speech enhancement effect may be improved.

In some embodiments, the noise reduction accuracy of the speech enhancement network may be determined through a plurality of methods. A process of determining the noise reduction accuracy of the speech enhancement network in operation 204 is described below.

In some embodiments, the noise reduction accuracy of the speech enhancement network may be determined by computing a scale-invariant signal-to-noise ratio, a mean absolute error, and a mean squared error. A scale-invariant signal-to-noise ratio between the enhanced speech sample and the clean speech sample, a mean absolute error between the enhanced speech sample and the clean speech sample, and a mean squared error between the enhanced speech sample and the clean speech sample are determined; and the scale-invariant signal-to-noise ratio, the mean absolute error, and the mean squared error are weighted, and the noise reduction accuracy of the speech enhancement network is obtained.

In some embodiments, a mean absolute error between the enhanced speech sample and the clean speech sample, for example, an L1 loss, is recorded as L1ₜ. A mean value of absolute differences between the enhanced speech sample and the clean speech sample may be computed, to obtain a mean absolute error.

In some embodiments, a mean squared error between the enhanced speech sample and the clean speech sample, for example, an L2 loss, is recorded as L2ₜ. A square of a difference between each of two enhanced speech samples and the clean speech sample may be computed, and then a mean value of the squares of the differences is computed, to obtain a mean squared error.

In some embodiments, a scale-invariant signal-to-noise ratio between the enhanced speech sample and the clean speech sample, for example, an SI-SNR loss, is recorded as L_{SI-SNR}, and may be configured for comparing a magnitude ratio of the enhanced speech sample signal to the clean speech sample signal, to measure the enhancement effect. Since the enhanced speech sample is generated by the model, and overall energy of the enhanced speech sample is not necessarily identical to that of the clean speech sample, a scale coefficient may be computed, to adjust volume of the enhanced speech sample. Thus, the enhanced speech sample has similar energy to the clean speech sample. Subsequently, the enhanced speech sample is multiplied by the scale coefficient, and an estimated source signal is obtained. By computing a difference between the estimated source signal and the clean speech sample, an error of the estimated signal is obtained. The power of the clean speech sample and the power of the enhanced speech sample are computed. Finally, the scale-invariant signal-to-noise ratio is computed. In some embodiments, the scale-invariant signal-to-noise ratio L_{SI-SNR} may be obtained according to a formula as follows:

$${L}_{SI - SNR} = - 10 \times log 10 ( power\_s / power\_e )$$

In the formula, power_s denotes the power of the clean speech sample sₙ, and power_e denotes the power of the sample enhancement speech \tilde{s}ₙ.

Finally, in some embodiments, the noise reduction loss Lt (Sₙ, Sₙ) configured for reflecting the noise reduction accuracy may be obtained as follows:

$${L}_{t} ( {s}_{n} , {\tilde{s}}_{n} ) = {K}_{3} L {1}_{t} + {K}_{4} L {2}_{t} + {K}_{5} {L}_{SI - SNR}$$

In the formula, K₃ denotes a coefficient of the L1 loss, K₄ denotes a coefficient of the L2 loss, and K₅ denotes a coefficient of the SI-SNR loss.

A process of obtaining the speech enhancement accuracy is described below.

In some embodiments, the speech enhancement model is trained based on a deep learning speech enhancement and noise reduction solution, and a noisy speech signal is generated by mixing a clean speech data set with a noise data set. By controlling a noise mixing ratio, signal-to-noise ratios of noisy speech under different noise environments are simulated. Assuming that sₙ denotes the clean speech sample signal, dₙ denotes the noise sample signal, and Sₖ and Dₖ denote the corresponding short-time cosine transforms respectively, \tilde{s}ₙ denoting the enhanced speech sample, and \tilde{S}ₖ denoting the target frequency-domain feature,
xₙ=sₙ+dₙ denotes the noisy speech sample signal;
the short-time cosine is expressed as Xₖ=Sₖ +Dₖ;

$${m}_{k} = \frac{{S}_{k}}{{X}_{k}}$$

denotes an ideal mask output by the network model; and
L=Lₜ(sₙ,\tilde{s}ₙ)+Lᵥ(Vₛ,V_{\tilde{s}}) denotes a function configured for reflecting an overall loss of the speech enhancement accuracy.

Finally, the overall loss is obtained as L. The speech enhancement network is trained based on the overall loss, and thus a capability of the speech enhancement network to suppress noises in the non-speech segment can be emphatically improved. When noise reduction is performed on a to-be-processed speech based on the trained speech enhancement network, for the to-be-processed speech encompassing the non-speech segment, the trained speech enhancement network can effectively reduce residual noises, so that the speech enhancement quality can be improved.

In some embodiments, the enhanced speech sample and another clean speech may be configured as a first to-be-discriminated speech pair, and input to a first discriminator, to determine the noise reduction accuracy of the speech enhancement network based on a scoring result output by the first discriminator. Another clean speech except for the clean speech sample is acquired, the enhanced speech sample and another clean speech are configured as the first to-be-discriminated speech pair, and the first to-be-discriminated speech pair is input to the first discriminator; authenticity of the first to-be-discriminated speech pair is scored based on the first discriminator, and a first scoring result is obtained; and a first adversarial loss is determined according to the first scoring result, and the noise reduction accuracy of the speech enhancement network is determined according to the first adversarial loss.

Another clean speech except for the clean speech sample is obtained to improve diversity and a generalization capability of the training data. Another clean speech may be the remaining clean speech in the same batch of clean speech samples. By introducing another clean speech, the speech enhancement network can better learn different types of speech features and noise reduction modes, and thus the adaptability of the speech enhancement network in a real scenario can be improved.

The speech enhancement network, as a generator, is to generate speech output similar to the clean speech sample. The first discriminator, as a discriminator, serves as a part of the generative adversarial network (GAN), and is to determine authenticity of the first to-be-discriminated speech pair input. In a training process, a weight of the generator is optimized through back propagation, and speech generated by the generator is closer to the clean speech, and thus the first discriminator is deceived. Thus, a noise reduction loss configured for reflecting the noise reduction accuracy of the speech enhancement network is determined according to the first adversarial loss, and adversarial performance and a conversion capability of the generator can be taken into account in the training process. Thus, the speech generated is more authentic and higher in quality.

The first to-be-discriminated speech pair, a speech pair composed of the enhanced speech sample and another clean speech, may be input to the first discriminator for authenticity scoring subsequently. The first to-be-discriminated speech pair is configured for evaluating the authenticity of the speech output by the generator. By forming the speech pair by the enhanced speech sample and another clean speech, and inputting the speech pair to the first discriminator for scoring, a difference between the speech output by the generator and the clean speech can be determined.

The authenticity scoring indicates that the first discriminator scores the first to-be-discriminated speech pair, and is configured for measuring the authenticity of the speech in the speech pair input, for example, configured for measuring whether the two speeches in the speech pair input are identical. A higher scoring result indicates that the first discriminator deems that the two speeches in the speech pair are closer and more likely to be identical. The first adversarial loss may be computed according to the first scoring result. In some embodiments, a least squares loss or a cross-entropy loss may be used as the first adversarial loss, to measure a difference between the enhanced speech sample generated and another clean speech.

In some embodiments, a plurality of methods are available to determine the noise reduction loss of the speech enhancement network according to the first adversarial loss. For example, the noise reduction loss may be computed in a weighted mode along with other loss values, and the speech enhancement network taken as the generator is optimized through adversarial training in the training process. For example, updating a weight of the generator by maximizing the first adversarial loss between the speech output by the generator and another clean speech includes: the noise reduction loss of the generator is defined as maximizing the score made by the first discriminator on the speech generated according to the first scoring result. Thus, the generator can learn to generate output closer to authentic speech. The noise reduction loss is further determined by computing gradient information of speech output by the generator for the first discriminator. A gradient of the speech generated for the score made by the first discriminator may be computed, and taken as a target noise reduction loss of the generator. Thus, the generator generates the output closer to the authentic speech. A feature matching loss is introduced between the output of the generator and the authentic speech. The noise reduction loss is determined by comparing a similarity between speech features, which includes: statistical characteristics, such as a spectral shape and a speed, of the output of the generator and the authentic speech in some feature spaces are compared, and the feature matching loss is taken as the noise reduction loss of the generator.

In some embodiments, the noise reduction accuracy of the speech enhancement network is determined according to the first adversarial loss. The adversarial performance and the conversion capability of the generator may be taken into account in the training process, so that the speech generated by the speech enhancement network is more authentic and higher in quality.

In some embodiments, a second discriminator may be added to further determine the noise speech, and thus the noise reduction accuracy of the speech enhancement network may be determined. A reference noise speech is separated from the noisy speech sample based on the enhanced speech sample; the reference noise speech and the noise sample are configured as a second to-be-discriminated speech pair, and input to the second discriminator; authenticity of the second to-be-discriminated speech pair is scored based on the second discriminator, and a second scoring result is obtained; and a second adversarial loss is determined according to the second scoring result, and the noise reduction accuracy of the speech enhancement network is determined according to the first adversarial loss and the second adversarial loss.

The second discriminator is introduced to enhance the performance of the speech enhancement network, and improve a capability to separate noises. The authenticity of the second to-be-discriminated speech pair is scored by the second discriminator. Thus, a learning process of the speech enhancement network can be guided, and the speech enhancement network can better restore the clean speech and reduce noise components.

The speech enhancement network, as a generator, is to generate speech output similar to the clean speech sample. The second discriminator, as a discriminator, is a model configured for evaluating a similarity between the speech generated and the noise sample. The second discriminator scores the authenticity of the speech generated according to the second to-be-discriminated speech pair (including the reference noise speech and the noise sample) input. By scoring the second to-be-discriminated speech pair, the second discriminator may assist in determining the quality of the speech generated.

The second to-be-discriminated speech pair indicates a speech pair used in the method for enhancing speech, and includes the reference noise speech and the noise sample. The reference noise speech is a noise portion separated from the enhanced speech sample, and the noise sample is noise speech configured for being mixed with the clean speech sample, to obtain the noisy speech sample. The second to-be-discriminated speech pair is scored by transferring the reference noise speech and the noise sample as input to the second discriminator. The second discriminator evaluates the authenticity of the speech generated according to the similarity between the two speech samples. By comparing second scoring result, the proximity between the speech generated and the noise speech may be determined, to compute and determine the second adversarial loss. Thus, the training process of the speech enhancement network is guided.

The authenticity scoring indicates that the second discriminator scores the second to-be-discriminated speech pair, and is configured for measuring the authenticity of the speech in the speech pair input, for example, configured for measuring whether the two speeches in the speech pair input are identical.

In some embodiments, a plurality of methods are available to determine the noise reduction accuracy of the speech enhancement network according to the first adversarial loss and the second adversarial loss. For example, the noise reduction loss configured for reflecting the noise reduction accuracy may be obtained by weighting the first adversarial loss and the second adversarial loss along with other loss values. The speech enhancement network taken as the generator is optimized through adversarial training in the training process.

In the above implementation, by introducing the second discriminator, the proximity between the reference noise speech in the noisy speech sample generated and the noise sample, so that the second adversarial loss is determined. The training process of the speech enhancement network is guided through the second adversarial loss. Thus, the speech enhancement network can better restore the clean speech and reduce the noise components.

A process of determining the speech classification loss and the noise reduction loss through different methods and a process of obtaining the overall loss in some embodiments are described below with reference to the accompanying drawings.

With reference to FIG. 6, a schematic diagram of an exemplary process of obtaining an overall loss according to some embodiments is shown in FIG. 6. In the example, the speech classification loss may be computed with reference to the effectiveness distribution and the effectiveness distribution label. The clean speech sample is mixed with the noise sample, and the noisy speech sample is obtained. The noisy speech sample is input to the speech enhancement network for processing, and the enhanced speech sample is obtained. The enhanced speech sample is framed, and n enhanced speech frames including an enhanced speech frame 1, an enhanced speech frame 2, . . . , and an enhanced speech frame n are obtained, n being greater than 1. The speech effectiveness of the n enhanced speech frames is classified, and the effectiveness distribution is obtained. Each frame in the clean speech sample encompasses m effectiveness distribution labels including an effectiveness distribution label 1, an effectiveness distribution label 2, . . . , and an effectiveness distribution label m, m being greater than 1. An effectiveness label feature is obtained with reference to the m effectiveness distribution labels. Finally, the speech classification loss is computed according to the effectiveness classification feature and the effectiveness label feature.

In some embodiments, the noise reduction loss may be computed according to the clean speech sample and the enhanced speech sample. After the enhanced speech sample is obtained, a scale-invariant signal-to-noise ratio, a mean absolute error, and a mean squared error generated in a training process may be computed according to the clean speech sample and the enhanced speech sample separately. The noise reduction loss is computed based on the scale-invariant signal-to-noise ratio, the mean absolute error, and the mean squared error.

Finally, after the noise reduction loss and the speech classification loss are obtained, the overall loss may be obtained through weighting. A parameter of the speech enhancement network is adjusted according to the overall loss.

The noise reduction loss and the speech classification loss are separately determined in a supervised mode, so that the accuracy and reliability of the noise reduction loss and the speech classification loss can be improved separately. Thus, the accuracy and reliability of the overall loss can be improved as a whole, and a training effect of a speech enhancement network can be improved.

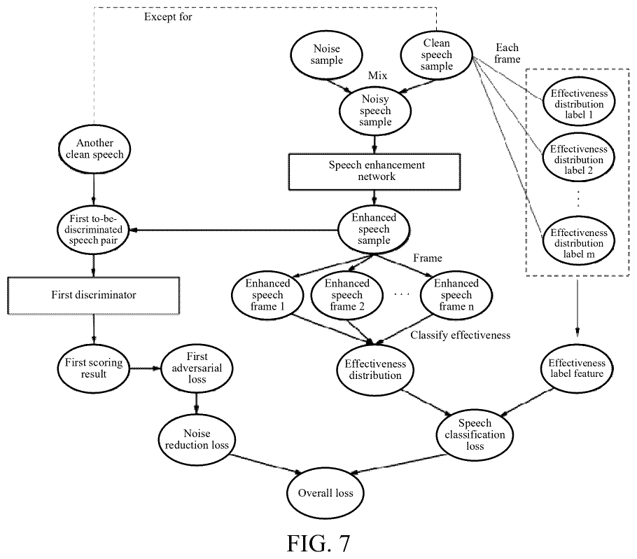

With reference to FIG. 7, a schematic diagram of another exemplary process of obtaining an overall loss according to some embodiments is shown in FIG. 7. In the example, the speech classification loss may be computed with reference to the effectiveness distribution and the effectiveness distribution label. The clean speech sample is mixed with the noise sample, and the noisy speech sample is obtained. The noisy speech sample is input to the speech enhancement network for processing, and the enhanced speech sample is obtained. The enhanced speech sample is framed, and n enhanced speech frames including an enhanced speech frame 1, an enhanced speech frame 2, . . . , and an enhanced speech frame n are obtained, n being greater than 1. The effectiveness of the n enhanced speech frames is classified, and the effectiveness distribution is obtained. Each frame in the clean speech sample encompasses m effectiveness distribution labels including an effectiveness distribution label 1, an effectiveness distribution label 2, . . . , and an effectiveness distribution label m, m being greater than 1. An effectiveness label feature is obtained with reference to the m effectiveness distribution labels. Finally, the speech classification loss is computed according to the effectiveness classification feature and the effectiveness label feature.

In some embodiments, the noise reduction loss may be computed according to another clean speech except for the clean speech sample and the enhanced speech sample. After another clean speech except for the clean speech sample is obtained, another clean speech and the enhanced speech sample are formed into the first to-be-discriminated speech pair. The first to-be-discriminated speech pair is input to the first discriminator for authenticity scoring, and the first scoring result is obtained. The first adversarial loss is computed based on the first scoring result. Finally, the noise reduction loss is determined according to the first adversarial loss.

Finally, after the noise reduction loss and the speech classification loss are obtained, the overall loss may be obtained through weighting. A parameter of the speech enhancement network is adjusted according to the overall loss.

The noise reduction loss is determined in an unsupervised mode, so that the efficiency of determining the noise reduction loss can be improved. The accuracy and reliability of the speech classification loss can be improved by determining the speech classification loss in a supervised mode. Thus, the efficiency, accuracy, and reliability of determining the overall loss can be taken into account as a whole, and a training effect of the speech enhancement network can be improved.

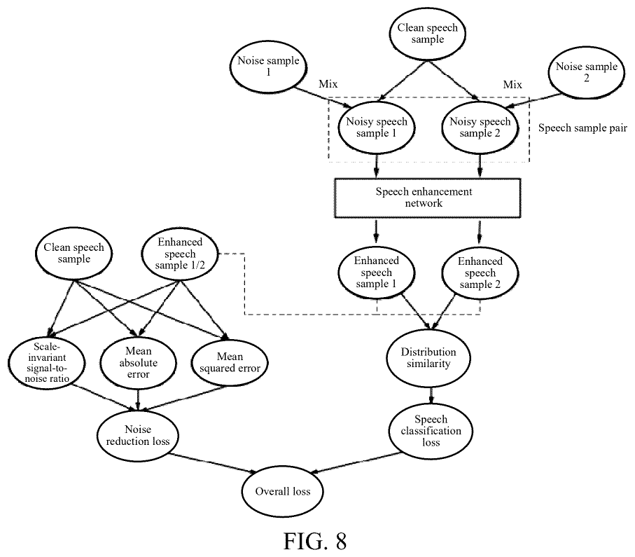

With reference to FIG. 8, a schematic diagram of yet another exemplary process of obtaining an overall loss according to some embodiments is shown in FIG. 8. In the example, the speech classification loss may be computed after comparative learning is performed on different noisy speech sample. The same clean speech sample may be mixed with two different noise samples. For example, noise sample 1 is mixed to obtain a noisy speech sample 1, and a noise sample 2 is mixed to obtain a noisy speech sample 2. The two noisy speech samples obtained are configured as a speech sample pair, and input to the speech enhancement network separately, and an enhanced speech sample 1 and an enhanced speech sample 2 are output respectively. A distribution similarity between effectiveness distribution corresponding to the two enhanced speech samples respectively is determined, and the speech classification loss of the speech enhancement network is determined according to the distribution similarity.

In some embodiments, the noise reduction loss may be computed according to the clean speech sample and the enhanced speech sample. After the enhanced speech sample is obtained, a scale-invariant signal-to-noise ratio, a mean absolute error, and a mean squared error generated in a training process may be computed according to the clean speech sample and the enhanced speech sample separately. The noise reduction loss is computed based on the scale-invariant signal-to-noise ratio, the mean absolute error, and the mean squared error.

Finally, after the noise reduction loss and the speech classification loss are obtained, the overall loss may be obtained through weighting. A parameter of the speech enhancement network is adjusted according to the overall loss.

The noise reduction loss is determined in a supervised mode, so that the accuracy and reliability of the noise reduction loss can be improved. The efficiency of determining the speech classification loss can be improved by determining the speech classification loss in an unsupervised mode. Thus, the efficiency, accuracy, and reliability of determining the overall loss can be taken into account as a whole, and a training effect of the speech enhancement network can be improved.

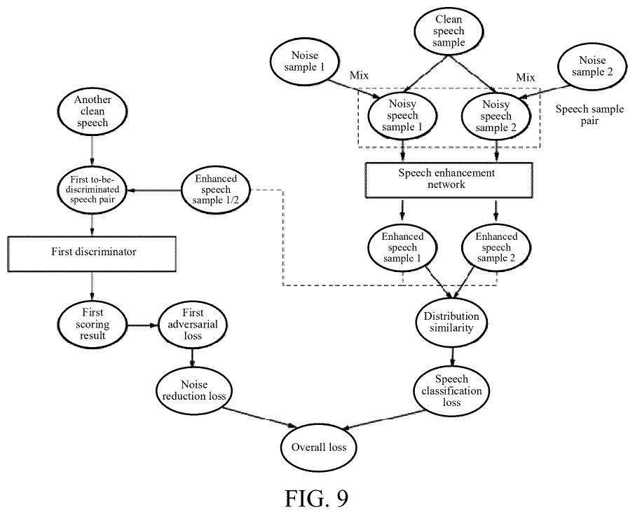

With reference to FIG. 9, a schematic diagram of yet another exemplary process of obtaining an overall loss according to some embodiments is shown in FIG. 9. In the example, the speech classification loss may be computed after comparative learning is performed on different noisy speech sample. The same clean speech sample may be mixed with two different noise samples. For example, a noise sample 1 is mixed to obtain a noisy speech sample 1, and a noise sample 2 is mixed to obtain a noisy speech sample 2. The two noisy speech samples obtained are configured as a speech sample pair, and input to the speech enhancement network separately, and an enhanced speech sample 1 and an enhanced speech sample 2 are output respectively. A distribution similarity between effectiveness distribution corresponding to the two enhanced speech samples respectively is determined, and the speech classification accuracy of the speech enhancement network is determined according to the distribution similarity.

In some embodiments, the noise reduction loss may be computed according to another clean speech except for the clean speech sample and the enhanced speech sample. After another clean speech except for the clean speech sample is obtained, another clean speech and the enhanced speech sample are formed into the first to-be-discriminated speech pair. The first to-be-discriminated speech pair may be formed according to the enhanced speech sample 1 and the enhanced speech sample 2 separately, and input to the first discriminator for authenticity scoring, and the first scoring result may be obtained. The first adversarial loss is computed based on the first scoring result. Finally, the noise reduction loss is determined according to the first adversarial loss.

Finally, after the noise reduction loss and the speech classification loss are obtained, the overall loss may be obtained through weighting. A parameter of the speech enhancement network is adjusted according to the overall loss.

The noise reduction loss and the speech classification loss are separately determined in an unsupervised mode, so that the efficiency of determining the noise reduction loss and the speech classification accuracy can be improved separately. Thus, the efficiency of determining the overall loss can be improved as a whole, and a training effect of the speech enhancement network can be improved.

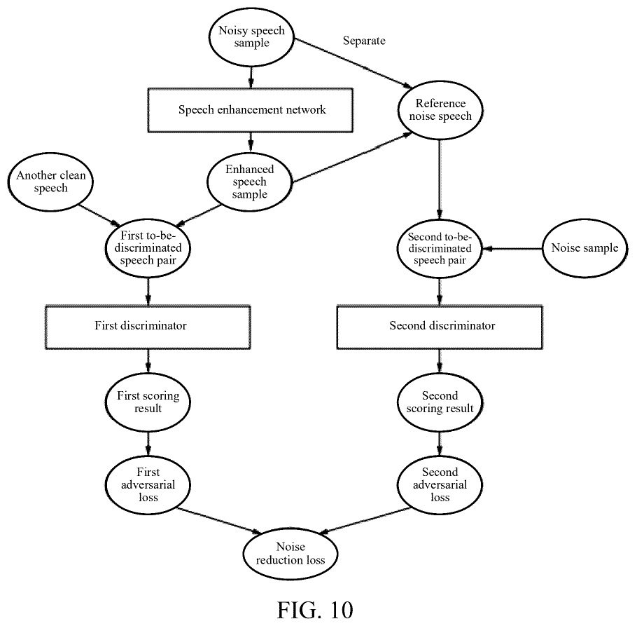

With reference to FIG. 10, a schematic diagram of an exemplary process of obtaining a noise reduction loss according to some embodiments is shown in FIG. 10. In the example, the noise reduction loss may be obtained in combination with the first adversarial loss and the second adversarial loss. In some embodiments, the first adversarial loss may be computed according to another clean speech except for the clean speech sample and the enhanced speech sample. After another clean speech except for the clean speech sample is obtained, another clean speech and the enhanced speech sample are formed into the first to-be-discriminated speech pair. The first to-be-discriminated speech pair may be formed according to the enhanced speech sample 1 and the enhanced speech sample 2 separately, and input to the first discriminator for authenticity scoring, and the first scoring result may be obtained. The first adversarial loss is computed based on the first scoring result.

In some embodiments, the second adversarial loss may be computed according to the reference noise speech separated from the noisy speech sample and the noise sample. The reference noise speech is separated from the noisy speech sample based on the enhanced speech sample. The reference noise speech and the noise sample are configured as the second to-be-discriminated speech pair, the second to-be-discriminated speech pair is input to the second discriminator for authenticity scoring, and the second scoring result is obtained. The second adversarial loss is computed based on the second scoring result.

Finally, after the first adversarial loss and the second adversarial loss are obtained, the noise reduction loss may be obtained through weighting. The overall loss is obtained according to the new noise reduction loss determined and the new speech classification loss determined, to adjust a parameter of the speech enhancement network.

In addition to the above methods, the speech classification loss and the noise reduction loss may be obtained in combination with the L1 loss, the L2 loss, the BCE loss, and the SI-SNR loss by selecting proper loss weighting.

The noise reduction loss is obtained in combination with the first adversarial loss and the second adversarial loss. Thus, the accuracy and reliability of the noise reduction loss can be effectively improved, and the accuracy and reliability of the overall loss can be further improved.

Through the above method for enhancing speech, in some embodiments, testing may be performed before application. In some embodiments, speech noise separation is performed on a self-created test data set, and a batch of test data are generated according to a signal-to-noise ratio range [−10, 30] dB, with the stride of 2 dB. 1000 groups of test data are obtained in total. A perceptual evaluation of speech quality (PESQ), a scale-invariant signal-to-noise ratio (SI-SNR), and a mean opinion score objective listening (MOS_OVL) that simulates a subjective audio quality perceptual parameter are selected as effect evaluation indexes. The PESQ is configured for measuring a difference between a quality of speech after sound processing or transmission and a quality of an original clean speech. The SI-SNR is configured for measuring a ratio of a clean signal to noise between a separated speech signal and an original speech signal. The MOS_OVL is configured for comparing a difference between the original speech signal and a processed speech signal, to provide an evaluation score configured for measuring the speech quality.

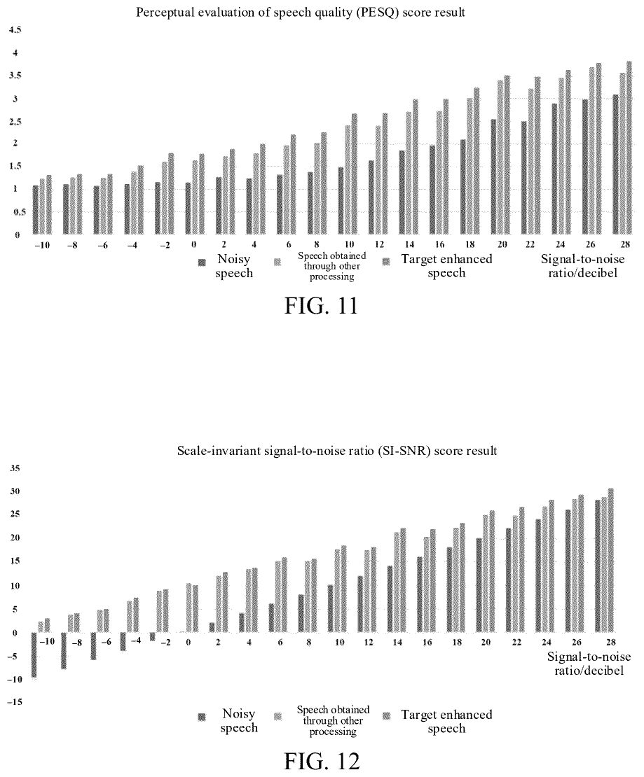

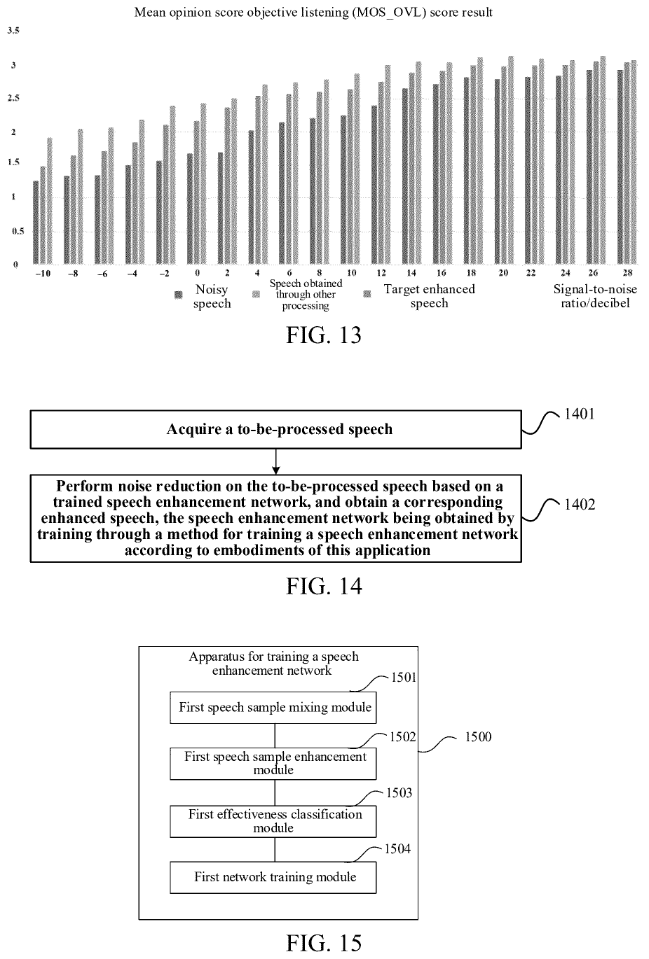

Corresponding results are shown in FIG. 11, FIG. 12, and FIG. 13. FIG. 11 is a schematic diagram of a PESQ score result in a test process according to some embodiments. FIG. 12 is a schematic diagram of an SI-SNR score result in a test process according to some embodiments. FIG. 13 is a schematic diagram of an MOS-OVL score result in a test process according to some embodiments. In FIG. 11 to FIG. 13, the signal-to-noise ratio (SNR) is an indicator configured for measuring relative strength between the signal and the noise, with decibel (dB) as a unit. The signal-to-noise ratio/decibel (SNR/dB) is configured for measuring relative strength or a quality difference between the speech signal and the noise. A higher SNR value indicates less noise disturbance, and a lower SNR value indicates more noise disturbance. In the figure, the noisy speech indicates the original speech signal on which no noise reduction is performed. The group of data may be taken as a reference for comparing effects of other processing methods. Speech obtained through other processing, for example, a speech signal without voice activity detection (w/o VAD), indicates a speech signal to which no method for enhancing speech in some embodiments is applied during noise reduction processing. The target enhanced speech, expressed as being proposed, indicates a speech signal obtained after noise reduction is performed through the method for enhancing speech. In some embodiments, the PESQ score result, the SI-SNR score result, and the MOS_OVL score result are all higher than those of other data. In some embodiments, the noise can be effectively suppressed, and the speech quality can be improved. A noise reduction effect of the model is significantly improved after a VAD auxiliary loss function is added.

Although the steps in each flowchart are displayed in sequence as instructed by arrows, these steps are not necessarily executed in sequence according to the sequence instructed by the arrows. The execution sequence of these steps is not strictly limited, and the steps can be executed in other sequences, unless indicated in some embodiments otherwise. At least some steps in the flowcharts can include a plurality of steps or a plurality of stages. These steps or stages are not necessarily executed at the same time, but can be executed at different time. These steps or stages are not necessarily executed in sequence, but can be executed in turn or alternately with other steps or at least some steps or stages of other steps.

With reference to FIG. 14, an exemplary schematic flowchart of a method for enhancing speech according to some embodiments is shown in FIG. 14. The method for enhancing speech may be performed by an electronic device, for example, the server 102 in FIG. 1. The method for enhancing speech includes, but is not limited to, the following operation 1401 to operation 1402.

Step 1401: Acquire a to-be-processed speech.

In some embodiments, the to-be-processed speech indicates an original speech signal on which speech enhancement may be performed, and may include noise or distortion, for example. The to-be-processed speech may be similar to a noisy speech sample in a training process. The to-be-processed speech, a speech in an actual scenario, is also mixed with some noises. The to-be-processed speech may be speech that is actually acquired from a call, a video conference, a speech recognition front end, or a live video on demand application, for example.

Operation 1402: Perform noise reduction on the to-be-processed speech based on a trained speech enhancement network, and obtain a corresponding enhanced speech. The speech enhancement network is obtained by training through the method for training a speech enhancement network according to some embodiments.

In some embodiments, the enhanced speech is an enhanced speech signal obtained after processed by the speech enhancement network. The noise reduction is performed on the to-be-processed speech based on the trained speech enhancement network, and output obtained is the enhanced speech. Through processing by the speech enhancement network, noises in the to-be-processed speech can be effectively reduced, and the speech quality can be improved. Residual noises in a non-speech segment can be reduced, so that definition and intelligibility of the enhanced speech can be enhanced.

The speech enhancement network is obtained by training according to the above method for training a speech enhancement network.

In some embodiments, the enhanced speech sample is framed into the plurality of enhanced speech frames, the speech effectiveness of each enhanced speech frame is classified, and the effectiveness distribution of the enhanced speech sample is generated according to the classification result of each enhanced speech frame. Since the effectiveness distribution may indicate whether each enhanced speech frame generated by the speech enhancement network is the non-speech segment, the recognition accuracy of the currently-trained speech enhancement network on the speech segment (for example, the speech signal encompassing the effective human sound) and the non-speech segment (for example, the speech signal encompassing no effective human sound, such as a mute signal and a noise signal) may be measured through the speech classification accuracy of the speech enhancement network determined through the effectiveness distribution. The speech enhancement accuracy of the speech enhancement network is determined according to the noise reduction accuracy and the speech classification accuracy, and the speech enhancement network is trained based on the speech enhancement accuracy, so that the capability of the speech enhancement network to recognize the speech segment and the non-speech segment can be improved, and the ability to suppress the noise in the non-speech segment can be improved. When the noise reduction on the to-be-processed speech is performed based on the trained speech enhancement network, for the to-be-processed speech encompassing the non-speech segment, the trained speech enhancement network can effectively reduce the residual noises in the non-speech segment, and thus the speech enhancement quality can be improved.

Although the steps in each flowchart are displayed in sequence as instructed by arrows, these steps are not necessarily executed in sequence according to the sequence instructed by the arrows. The execution sequence of these steps is not strictly limited, and the steps can be executed in other sequences, unless indicated in some embodiments otherwise. At least some steps in the flowcharts can include a plurality of steps or a plurality of stages. These steps or stages are not necessarily executed at the same time, but can be executed at different time. These steps or stages are not necessarily executed in sequence, but can be executed in turn or alternately with other steps or at least some steps or stages of other steps.

With reference to FIG. 15, an exemplary schematic structural diagram of an apparatus for training a speech enhancement network according to some embodiments is shown in FIG. 15. The apparatus 1500 for training a speech enhancement network includes:
a first speech sample mixing module 1501 configured to acquire a clean speech sample and a noise sample, and mix the clean speech sample with the noise sample to form a noisy speech sample;
a first speech sample enhancement module 1502 configured to perform noise reduction on the noisy speech sample based on the speech enhancement network, and obtain an enhanced speech sample;
a first effectiveness classification module 1503 configured to frame the enhanced speech sample into a plurality of enhanced speech frames, classify speech effectiveness of each enhanced speech frame, and generate effectiveness distribution of the enhanced speech sample according to a classification result of each enhanced speech frame; and
a first network training module 1504 configured to determine noise reduction accuracy of the speech enhancement network according to the enhanced speech sample and the clean speech sample, determine speech classification accuracy of the speech enhancement network according to the effectiveness distribution, determine the speech enhancement accuracy of the speech enhancement network according to the noise reduction accuracy and the speech classification accuracy, and train the speech enhancement network based on the speech enhancement accuracy.

The above first network training module 1504 may be configured to:
acquire an effectiveness distribution label configured for indicating speech effectiveness of each frame in the clean speech sample; and
determine the speech classification accuracy of the speech enhancement network according to a similarity between the effectiveness distribution and the effectiveness distribution label.

Two noisy speech samples obtained through mixing with the same clean speech sample are configured as a speech sample pair. The above first network training module 1504 is further configured to:
determine a distribution similarity between effectiveness distributions respectively corresponding to two enhanced speech samples having a correspondence relation, the two enhanced speech samples having a correspondence relation being obtained by performing, based on the speech enhancement network, noise reduction on the two noisy speech samples included in the speech sample pair respectively and the two noisy speech samples included in the speech sample pair being generated based on the same clean speech sample; and determine the speech classification accuracy of the speech enhancement network according to the distribution similarity.

The above first effectiveness classification module 1503 may be configured to:
determine a time-domain energy parameter of each enhanced speech frame, the time-domain energy parameter being configured for indicating speech energy magnitude of the enhanced speech frame in a time domain; and
classify the speech effectiveness of each enhanced speech frame according to the time-domain energy parameter and a preset energy threshold.

The time-domain energy parameter includes a single-frame mean energy. The above first effectiveness classification module 1503 is further configured to:
determine comprehensive mean energy of the clean speech sample, weight the comprehensive mean energy according to the preset energy threshold, and obtain weighted mean energy;
determine, when the single-frame mean energy is greater than the weighted mean energy, that a classification result of the speech effectiveness of the enhanced speech frame is that the enhanced speech frame belongs to an effective speech frame; or determine, when the single-frame mean energy is less than or equal to the weighted mean energy, that a classification result of the speech effectiveness of the enhanced speech frame is that the enhanced speech frame does not belong to an effective speech frame.

The time-domain energy parameter includes single-frame short-time energy, and a plurality of preset energy thresholds are provided, the plurality of preset energy thresholds including a first energy threshold and a second energy threshold, and the first energy threshold being greater than the second energy threshold. The above first effectiveness classification module 1503 is further configured to:
determine, when the single-frame short-time energy is greater than the first energy threshold, that the classification result of the speech effectiveness of the enhanced speech frame is that the enhanced speech frame belongs to the effective speech frame; or
acquire, when the single-frame short-time energy is less than or equal to the first energy threshold and greater than the second energy threshold, a short-time mean zero-crossing rate of the enhanced speech frame, and determine, when the short-time mean zero-crossing rate is greater than a preset zero-crossing rate threshold, that the classification result of the speech effectiveness of the enhanced speech frame is that the enhanced speech frame belongs to the effective speech frame; or
acquire, when the single-frame short-time energy is less than or equal to the first energy threshold and greater than the second energy threshold, a short-time mean zero-crossing rate of the enhanced speech frame, and determine, when the short-time mean zero-crossing rate is less than or equal to a preset zero-crossing rate threshold, that the classification result of the speech effectiveness of the enhanced speech frame is that the enhanced speech frame does not belong to the effective speech frame; or
determine, when the single-frame short-time energy is less than or equal to the second energy threshold, that the classification result of the speech effectiveness of the enhanced speech frame is that the enhanced speech frame does not belong to the effective speech frame.

The above first network training module 1504 is further configured to:
determine a scale-invariant signal-to-noise ratio between the enhanced speech sample and the clean speech sample, a mean absolute error between the enhanced speech sample and the clean speech sample, and a mean squared error between the enhanced speech sample and the clean speech sample; and
weight the scale-invariant signal-to-noise ratio, the mean absolute error, and the mean squared error, and obtain the noise reduction accuracy of the speech enhancement network.

The above first network training module 1504 is further configured to:
acquire another clean speech except for the clean speech sample, configure the enhanced speech sample and the another clean speech as a first to-be-discriminated speech pair, and input the first to-be-discriminated speech pair to a first discriminator;
score authenticity of the first to-be-discriminated speech pair based on the first discriminator, and obtain a first scoring result; and
determine a first adversarial loss according to the first scoring result, and determine the noise reduction accuracy of the speech enhancement network according to the first adversarial loss.

The above first network training module 1504 is further configured to:
separate a reference noise speech from the noisy speech sample based on the enhanced speech sample;
configure the reference noise speech and the noise sample as a second to-be-discriminated speech pair, and input the second to-be-discriminated speech pair to the second discriminator;
score authenticity of the second to-be-discriminated speech pair based on the second discriminator, and obtain a second scoring result; and
determine a second adversarial loss according to the second scoring result, and determine the noise reduction accuracy of the speech enhancement network according to the first adversarial loss and the second adversarial loss.

The above first speech sample enhancement module 1502 may be configured to:
perform frequency-domain transform on the noisy speech sample, and obtain an original frequency-domain feature of the noisy speech sample;
map the original frequency-domain feature repeatedly based on the speech enhancement network, obtain a mapped feature, extract time sequence information from the mapped feature, obtain a time sequence feature, splice the mapped feature and the time sequence feature, obtain a spliced feature, map the spliced feature repeatedly, and obtain a transform mask;
modulate the original frequency-domain feature based on the transform mask, and obtain a target frequency-domain feature; and
perform inverse transform of the frequency-domain transform on the target frequency-domain feature, and obtain the enhanced speech sample.

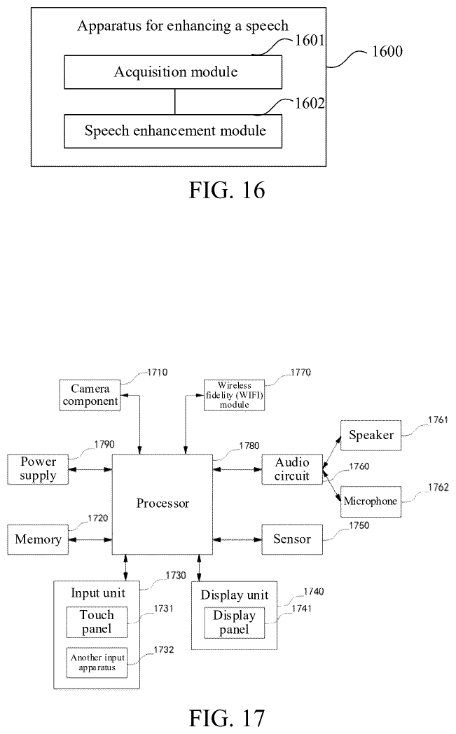

With reference to FIG. 16, an exemplary schematic structural diagram of an apparatus for enhancing speech according to some embodiments is shown in FIG. 16. The apparatus 1600 for enhancing speech includes:
an acquisition module 1601 configured to acquire a to-be-processed speech; and
a speech enhancement module 1602 configured to perform noise reduction on the to-be-processed speech based on a speech enhancement network, and obtain a corresponding enhanced speech, the speech enhancement network being obtained by training through the method for training a speech enhancement network according to some embodiments.

The electronic device according to some embodiments and configured to perform the above method for enhancing speech or the above method for training a speech enhancement network may be a terminal. With reference to FIG. 17, a block diagram of some structures of the terminal according to some embodiments is shown in FIG. 17. The terminal includes: a camera component 1710, a memory 1720, an input unit 1730, a display unit 1740, a sensor 1750, an audio circuit 1760, a wireless fidelity (WiFi) module 1770, a processor 1780, or a power supply 1790, for example. A person skilled in the art can understand that the terminal structure shown in FIG. 17 does not constitute a limitation to the terminal. The terminal can include more or fewer components than those shown, or combine some components, or have different component arrangement.

The camera component 1710 may be configured to collect images or videos. In some embodiments, the camera component 1710 includes a front-facing camera and a rear-facing camera. The front-facing camera is arranged on a front panel of the terminal, and the rear-facing camera is arranged on a back surface of the terminal. In some embodiments, at least two rear-facing cameras are provided, which are any ones of a main camera, a depth-of-field camera, a wide-angle camera, and a telephoto camera respectively, to achieve a background blur function through fusion of the main camera and the depth-of-field camera, a panoramic photographing and virtual reality (VR) photographing function through fusion of the main camera and the wide-angle camera, for example

The memory 1720 may be configured to store a software program and a module. The processor 1780 runs the software program and the module stored in the memory 1720, to perform various function applications and data processing of the terminal.

The input unit 1730 may be configured to receive input digit or character information, and generate button signal input related to settings and function control of the terminal. The input unit 1730 may include a touch panel 1731 and another input apparatus 1732.

The display unit 1740 may be configured to display information input or information provided, and various menus of the terminal. The display 1740 may include a display panel 1741.

The audio circuit 1760, a speaker 1761, and a microphone 1762 may provide audio interfaces.

The power supply 1790 may be an alternating current, a direct current, a primary battery, or a rechargeable battery.

One or more sensors 1750 may be provided, and include, but are not limited to, an acceleration sensor, a gyroscope sensor, a pressure sensor, or an optical sensor, for example.

The acceleration sensor may measure acceleration on three coordinate axes of a coordinate system established based on the terminal. For example, the acceleration sensor may be configured to measure components of gravity acceleration on the three coordinate axes. The processor 1780 may control the display unit 1740 to display the user interface (UI) in a landscape view or a portrait view according to a gravity acceleration signal collected by the acceleration sensor. The acceleration sensor may be further configured to collect motion data of a game or a user.

The gyroscope sensor may measure a body direction and a rotation angle of the terminal. The gyroscope sensor may cooperate with the acceleration sensor to acquire a three-dimensional (3D) action performed by the user on the terminal. The processor 1780 may implement the following functions according to the data collected by the gyroscope sensor: motion sensing (such as changing the UI according to a tilt operation of the user), image stabilization during photographing, game control, and inertial navigation.

The pressure sensor may be arranged on a side frame of the terminal and/or a lower layer of the display unit 1740. When the pressure sensor is arranged on the side frame of the terminal, a holding signal of the user on the terminal may be detected. The processor 1780 performs left and right hand recognition or a quick operation according to the holding signal collected by the pressure sensor. When the pressure sensor is arranged on the lower layer of the display unit 1740, the processor 1780 controls an operable control on the UI based on a pressure operation by the user on the display unit 1740. The operable control includes at least one of a button control, a scroll-bar control, an icon control, and a menu control.

The optical sensor is configured to collect environmental light intensity. In some embodiments, the processor 1780 may control the display brightness of the display unit 1740 according to the environmental light intensity collected by the optical sensor. When the environmental light intensity is higher, the display brightness of the display unit 1740 is increased; and when the environment light intensity is lower, the display brightness of the display unit 1740 is decreased. In some embodiments, the processor 1780 may further dynamically adjust a photographing parameter of the camera component 1710 according to the environmental light intensity collected by the optical sensor.

In some embodiments, the processor 1780 included in the terminal may perform the method for enhancing speech or the method for training a speech enhancement network in some embodiments.

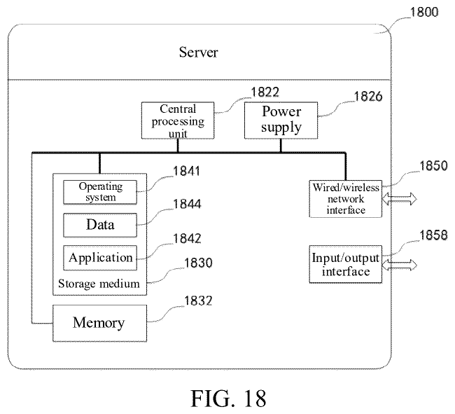

The electronic device according to some embodiments and configured to perform the above method for enhancing speech or the above method for training a speech enhancement network may be the server. With reference to FIG. 18, a block diagram of some structures of a server according to some embodiments is shown in FIG. 18. The server 1800 may vary greatly due to different configurations or performance, and may include one or more central processing units (CPUs) 1822 (for example, one or more processors), a memory 1832, and one or more storage media 1830 (for example, one or more mass storage apparatuses) having an application 1842 or data 1844 stored therein. The memory 1832 and the storage medium 1830 may be the transient storage or the persistent storage. A program stored in the storage medium 1830 may include one or more modules (not marked in the figure), and each module may include a series of instruction operations on the server 1800. The central processing unit 1822 may be configured to communicate with the storage medium 1830, and perform a series of instruction operations in the storage medium 1830 on the server 1800.

The server 1800 may further include one or more power supplies 1826, one or more wired or wireless network interfaces 1850, one or more input/output interfaces 1858, and/or one or more operating systems 1841 such as Windows Server™, Mac OS X™, Unix™, Linux™, FreeBSD™.

The processor in the server 1800 may be configured to perform the method for enhancing speech or the method for training a speech enhancement network.

A computer-readable storage medium is further provided in some embodiments. The computer-readable storage medium is configured to store program codes, the program codes being configured for performing the method for enhancing speech or the method for training a speech enhancement network according to some embodiments.

A computer program product is further provided in some embodiments. The computer program product includes a computer program, the computer program being stored in a computer-readable storage medium. A processor of a computer device reads the computer program from the computer-readable storage medium, and executes the computer program, to cause the computer device to perform the above method for enhancing speech or the above method for training a speech enhancement network.

In several embodiments provided in some embodiments, the system, apparatus, and method disclosed can be implemented in other modes. For example, some embodiments described above are illustrative. For example, the units are divided by logical function. Other division methods can be employed during actual implementation. For example, a plurality of units or components can be combined or integrated into another system, or some features can be ignored or not performed. Mutual coupling or direct coupling, or communication connection displayed or discussed can be implemented through some interfaces. Indirect coupling or communication connection between the apparatuses or units can be electronic or mechanical, for example.

The units described as separate parts can be physically separated or not. Parts displayed as units can be physical units or not. The parts can be located in one place or distributed over a plurality of network units. Some or all of the units can be selected, to achieve the objectives of the solution in some embodiments.

Each function unit in some embodiments can be integrated into one processing unit. Each unit can be physically separated. Two or more units can be integrated into one unit. The above integrated unit can be implemented in a form of hardware or a software function unit.

When implemented in the form of the software function unit and sold or used as an independent product, the integrated unit can be stored in one computer-readable storage medium. Based on such understanding, some embodiments can be embodied in a form of a software product. The computer software product is stored in one storage medium and includes several instructions configured for causing one computer apparatus (which can be a personal computer, a server, a network apparatus, for example) to perform all or some of the operations of the method in some embodiments. The foregoing storage medium includes: various media that can store program codes, such as a universal serial bus (USB) flash disk, a removable hard disk, a read-only memory (ROM), a random access memory (RAM), a magnetic disk, and an optical disk.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A method for training a speech enhancement network, performed by an electronic device, comprising:
acquiring a first clean speech sample and a noise sample, and mixing the first clean speech sample with the noise sample to generate a noisy speech sample;
performing noise reduction on the noisy speech sample based on the speech enhancement network to obtain an enhanced speech sample;
framing the enhanced speech sample into a plurality of enhanced speech frames, classifying speech effectiveness of the plurality of enhanced speech frames, and generating a first effectiveness distribution of the enhanced speech sample based on classification results of the plurality of enhanced speech frames; and
determining a noise reduction accuracy of the speech enhancement network based on the enhanced speech sample and the first clean speech sample, determining a speech classification accuracy of the speech enhancement network based on the first effectiveness distribution, determining a speech enhancement accuracy of the speech enhancement network based on the noise reduction accuracy and the speech classification accuracy, and training the speech enhancement network based on the speech enhancement accuracy.

2. The method according to claim 1, wherein the determining the speech classification accuracy comprises:
acquiring an effectiveness distribution label for indicating speech effectiveness of a plurality of frames in the first clean speech sample; and
determining the speech classification accuracy according to a similarity between the first effectiveness distribution and the effectiveness distribution label.

3. The method according to claim 1, wherein the determining the speech classification accuracy comprises:
generating a speech sample pair comprising two noisy speech samples using a same clean speech sample;
obtaining two enhanced corresponding speech samples by performing, based on the speech enhancement network, noise reduction on the two noisy speech samples;
determining a distribution similarity between a second effectiveness distribution corresponding to the two enhanced corresponding speech samples; and
determining the speech classification accuracy based on the distribution similarity.

4. The method according to claim 1, wherein the classifying the speech effectiveness of the plurality of enhanced speech frames comprises:
determining time-domain energy parameters for the plurality of enhanced speech frames, a time-domain energy parameter indicating a speech energy magnitude of an enhanced speech frame in a time domain; and
classifying the speech effectiveness of the plurality of enhanced speech frames based on the time-domain energy parameter and a preset energy threshold.

5. The method according to claim 4, wherein the time-domain energy parameter indicates a single-frame mean energy, and wherein the classifying the speech effectiveness of the plurality of enhanced speech frames comprises:
determining a comprehensive mean energy of the first clean speech sample, and weighting the comprehensive mean energy according to the preset energy threshold, to obtain a weighted mean energy; and
determining, based on the single-frame mean energy being greater than the weighted mean energy, that a first classification result of a speech effectiveness of a first enhanced speech frame indicates that the first enhanced speech frame belongs to an effective speech frame; and determining, based on the single-frame mean energy being less than or equal to the weighted mean energy, that the first classification result indicates that the first enhanced speech frame does not belong to the effective speech frame.

6. The method according to claim 5, wherein the time-domain energy parameter indicates a single-frame short-time energy, and wherein the classifying the speech effectiveness of the plurality of enhanced speech frames comprises:
determining, based on the single-frame short-time energy being greater than a first energy threshold, that the first classification result indicates that the first enhanced speech frame belongs to the effective speech frame;
acquiring, based on the single-frame short-time energy being less than or equal to the first energy threshold and greater than a second energy threshold, a short-time mean zero-crossing rate of the first enhanced speech frame, and determining, based on the short-time mean zero-crossing rate being greater than a preset zero-crossing rate threshold, that the first classification result indicates that the first enhanced speech frame belongs to the effective speech frame, wherein the first energy threshold is greater than the second energy threshold;
acquiring, based on the single-frame short-time energy being less than or equal to the first energy threshold and greater than the second energy threshold, the short-time mean zero-crossing rate of the first enhanced speech frame, and determining, based on the short-time mean zero-crossing rate being less than or equal to the preset zero-crossing rate threshold, that the first classification result indicates that the first enhanced speech frame does not belong to the effective speech frame; and
determining, based on the single-frame short-time energy being less than or equal to the second energy threshold, that the first classification result indicates that the first enhanced speech frame does not belong to the effective speech frame.

7. The method according to claim 1, wherein the determining the noise reduction accuracy comprises:
determining a scale-invariant signal-to-noise ratio between the enhanced speech sample and the first clean speech sample, a mean absolute error between the enhanced speech sample and the first clean speech sample, and a mean squared error between the enhanced speech sample and the first clean speech sample; and
weighting the scale-invariant signal-to-noise ratio, the mean absolute error, and the mean squared error, to obtain the noise reduction accuracy of the speech enhancement network.

8. The method according to claim 1, wherein the determining the noise reduction accuracy comprises:
acquiring a second clean speech sample, configuring the enhanced speech sample and the second clean speech sample as a first to-be-discriminated speech pair, and inputting the first to-be-discriminated speech pair into a first discriminator;
scoring authenticity of the first to-be-discriminated speech pair based on the first discriminator, to obtain a first scoring result; and
determining a first adversarial loss based on the first scoring result, and determining the noise reduction accuracy based on the first adversarial loss.

9. The method according to claim 8, wherein the determining the noise reduction accuracy comprises:
separating a reference noise from the noisy speech sample based on the enhanced speech sample;
configuring the reference noise and the noise sample as a second to-be-discriminated speech pair, and inputting the second to-be-discriminated speech pair into a second discriminator;
scoring authenticity of the second to-be-discriminated speech pair based on the second discriminator, to obtain a second scoring result; and
determining a second adversarial loss based on the second scoring result, and determining the noise reduction accuracy based on the first adversarial loss and the second adversarial loss.

10. The method according to claim 1, wherein the performing the noise reduction on the noisy speech sample comprises:
performing frequency-domain transform on the noisy speech sample to obtain an original frequency-domain feature of the noisy speech sample;
repeatedly mapping the original frequency-domain feature based on the speech enhancement network to obtain a mapped feature, extracting time sequence information from the mapped feature to obtain a time sequence feature, splicing the mapped feature and the time sequence feature to obtain a spliced feature, and repeatedly mapping the spliced feature to obtain a transform mask;
modulating the original frequency-domain feature based on the transform mask to obtain a target frequency-domain feature; and
performing inverse transform of the frequency-domain transform on the target frequency-domain feature to obtain the enhanced speech sample.

11. An apparatus for training a speech enhancement network, comprising:
at least one memory configured to store computer program code; and
at least one processor configured to read the program code and operate as instructed by the program code, the program code comprising:
speech sample mixing code configured to cause at least one of the at least one processor to acquire a first clean speech sample and a noise sample, and mix the first clean speech sample with the noise sample to generate a noisy speech sample;
speech sample enhancement code configured to cause at least one of the at least one processor to perform noise reduction on the noisy speech sample based on the speech enhancement network to obtain an enhanced speech sample;
effectiveness classification code configured to cause at least one of the at least one processor to frame the enhanced speech sample into a plurality of enhanced speech frames, classify speech effectiveness of the plurality of enhanced speech frames, and generate a first effectiveness distribution of the enhanced speech sample based on classification results of the plurality of enhanced speech frames; and
network training code configured to cause at least one of the at least one processor to determine a noise reduction accuracy of the speech enhancement network based on the enhanced speech sample and the first clean speech sample, determine a speech classification accuracy of the speech enhancement network based on the first effectiveness distribution, determine a speech enhancement accuracy of the speech enhancement network based on the noise reduction accuracy and the speech classification accuracy, and train the speech enhancement network based on the speech enhancement accuracy.

12. The apparatus according to claim 11, wherein the network training code is configured to cause at least one of the at least one processor to:
acquire an effectiveness distribution label for indicating speech effectiveness of a plurality of frames in the first clean speech sample; and
determine the speech classification accuracy according to a similarity between the first effectiveness distribution and the effectiveness distribution label.

13. The apparatus according to claim 11, wherein the network training code is configured to cause at least one of the at least one processor to:
generate a speech sample pair comprising two noisy speech samples using a same clean speech sample;
obtain two enhanced corresponding speech samples by performing, based on the speech enhancement network, noise reduction on the two noisy speech samples;
determine a distribution similarity between a second effectiveness distribution corresponding to the two enhanced corresponding speech samples; and
determine the speech classification accuracy based on the distribution similarity.

14. The apparatus according to claim 11, wherein the effectiveness classification code is configured to cause at least one of the at least one processor to:
determine time-domain energy parameters for the plurality of enhanced speech frames, a time-domain energy parameter indicating a speech energy magnitude of an enhanced speech frame in a time domain; and
classify the speech effectiveness of the plurality of enhanced speech frames based on the time-domain energy parameter and a preset energy threshold.

15. The apparatus according to claim 14, wherein the time-domain energy parameter indicates a single-frame mean energy, and wherein the effectiveness classification code is configured to cause at least one of the at least one processor to:
determine a comprehensive mean energy of the first clean speech sample, and weight the comprehensive mean energy according to the preset energy threshold, to obtain a weighted mean energy; and
determine, based on the single-frame mean energy being greater than the weighted mean energy, that a first classification result of a speech effectiveness of a first enhanced speech frame indicates that the first enhanced speech frame belongs to an effective speech frame; and determine, based on the single-frame mean energy being less than or equal to the weighted mean energy, that the first classification result indicates that the first enhanced speech frame does not belong to the effective speech frame.

16. The apparatus according to claim 15, wherein the time-domain energy parameter indicates a single-frame short-time energy, and wherein the effectiveness classification code is configured to cause at least one of the at least one processor to:
determine, based on the single-frame short-time energy being greater than a first energy threshold, that the first classification result indicates that the first enhanced speech frame belongs to the effective speech frame;
acquire, based on the single-frame short-time energy being less than or equal to the first energy threshold and greater than a second energy threshold, a short-time mean zero-crossing rate of the first enhanced speech frame, and determine, based on the short-time mean zero-crossing rate being greater than a preset zero-crossing rate threshold, that the first classification result indicates that the first enhanced speech frame belongs to the effective speech frame, wherein the first energy threshold is greater than the second energy threshold;
acquire, based on the single-frame short-time energy being less than or equal to the first energy threshold and greater than the second energy threshold, the short-time mean zero-crossing rate of the first enhanced speech frame, and determine, based on the short-time mean zero-crossing rate being less than or equal to the preset zero-crossing rate threshold, that the first classification result indicates that the first enhanced speech frame does not belong to the effective speech frame; and
determine, based on the single-frame short-time energy being less than or equal to the second energy threshold, that the first classification result indicates that the first enhanced speech frame does not belong to the effective speech frame.

17. The apparatus according to claim 11, wherein the network training code is configured to cause at least one of the at least one processor to:
determine a scale-invariant signal-to-noise ratio between the enhanced speech sample and the first clean speech sample, a mean absolute error between the enhanced speech sample and the first clean speech sample, and a mean squared error between the enhanced speech sample and the first clean speech sample; and
weight the scale-invariant signal-to-noise ratio, the mean absolute error, and the mean squared error, to obtain the noise reduction accuracy of the speech enhancement network.

18. The apparatus according to claim 11, wherein the determining the network training code is configured to cause at least one of the at least one processor to:
acquire a second clean speech sample, configure the enhanced speech sample and the second clean speech sample as a first to-be-discriminated speech pair, and input the first to-be-discriminated speech pair into a first discriminator;
score authenticity of the first to-be-discriminated speech pair based on the first discriminator, to obtain a first scoring result; and
determine a first adversarial loss based on the first scoring result, and determine the noise reduction accuracy based on the first adversarial loss.

19. The apparatus according to claim 18, wherein the network training code is configured to cause at least one of the at least one processor to:
separate a reference noise from the noisy speech sample based on the enhanced speech sample;
configure the reference noise and the noise sample as a second to-be-discriminated speech pair, and input the second to-be-discriminated speech pair into a second discriminator;
score authenticity of the second to-be-discriminated speech pair based on the second discriminator, to obtain a second scoring result; and
determine a second adversarial loss based on the second scoring result, and determine the noise reduction accuracy based on the first adversarial loss and the second adversarial loss.

20. A non-transitory computer-readable storage medium, storing computer code which, when executed by at least one processor, causes the at least one processor to at least:
acquire a first clean speech sample and a noise sample, and mix the first clean speech sample with the noise sample to generate a noisy speech sample;
perform noise reduction on the noisy speech sample based on the speech enhancement network to obtain an enhanced speech sample;
frame the enhanced speech sample into a plurality of enhanced speech frames, classify speech effectiveness of the plurality of enhanced speech frames, and generate a first effectiveness distribution of the enhanced speech sample based on classification results of the plurality of enhanced speech frames; and
determine a noise reduction accuracy of the speech enhancement network based on the enhanced speech sample and the first clean speech sample, determine a speech classification accuracy of the speech enhancement network based on the first effectiveness distribution, determine a speech enhancement accuracy of the speech enhancement network based on the noise reduction accuracy and the speech classification accuracy, and train the speech enhancement network based on the speech enhancement accuracy.
